(19) United States
(12) Patent Application Publication
(10) Pub. No.: US 2013/0201660 A1
(43) Pub. Date: Aug. 8, 2013

(54) OPTICAL FILM WITH ANTI-WARP SURFACE

(71) Applicant: Anthony H. Barbier, Las Gatos, CA (US)

(72) Inventor: Anthony H. Barbier, Las Gatos, CA (US)

(21) Appl. No.: 13/503,905

(22) PCT Filed: Oct. 22, 2010
(86) PCT No.: PCT/US2010/053771

§ 371 Date: Mar. 28, 2013

Related U.S. Application Data
(60) Provisional application No. 61/255,456, filed on Oct. 27, 2009.

(51) Int. Cl. F21V 5/02; B32B 33/00; G02B 5/04

(52) U.S. Cl. CPC F21V 5/02; G02B 5/04; B32B 33/00
USPC 362/97.1; 359/485.06; 428/141

(57) ABSTRACT

An optical film stack includes a first optical film (220) having a first major surface and a second major surface. The second major surface (160) is a matte surface having a plurality of microstructures (241). The optical film stack includes a second optical film (230) having a third major surface and a fourth major surface. The third major surface of the second optical film is adjacent to the matte surface of the first optical film. The coefficient of friction, between the matte surface of the first optical film and the third major surface of the second optical film is less than about 1. The coefficient 241 of friction less than about 1 provided by the matte surface enhances the warp performance of the optical film stack.

### RELATED APPLICATIONS

This application is related to pending U.S. Patent Publication No. 2009/0029054; U.S. Provisional Patent Application “Light Redirecting Film and Display System Incorporating Same”, (Attorney Docket No. 65425US002) filed Jun. 2, 2009 and having Ser. No. 61/183,154; and U.S. Provisional Patent Application “Light Redirecting Film and Display System Incorporating Same”, (Attorney Docket No. 65622US002) filed Aug. 25, 2009 and having Ser. No. 61/236,772; all of which are incorporated herein in their entireties by reference.

### FIELD OF THE INVENTION

This invention generally relates to optical films. The invention is further applicable to optical systems, such as display systems, incorporating such optical films.

### BACKGROUND

Display systems, such as liquid crystal display (LCD) systems, are used in a variety of applications and commercially available devices, for example, computer monitors, personal digital assistants (PDAs), mobile phones, miniature music players, and thin LCD televisions. Most LCDs include a liquid crystal panel and an extended area light source, often referred to as a backlight, for illuminating the liquid crystal panel. Backlights typically include one or more lamps and a number of light management films such as, lightguides, mirror films, light redirecting films, retarder films, light polarizing films, and diffuser films.

There is a continuing need to improve optical films and optical systems to achieve brighter, more compact, lower power displays with fewer visible and/or optical defects. The present invention fulfills these and other needs, and offers other advantages over the prior art.

### SUMMARY OF THE INVENTION

One embodiment involves an optical film stack including a first optical film having a first major surface and a second major surface, the second major surface comprising a matte surface including a plurality of microstructures and a second optical film having a third major surface and a fourth major surface, the third major surface of the second optical film adjacent to the matte surface of the first optical film, wherein a coefficient of friction between the first optical film and the second optical film is less than about 1.

Another embodiment involves a polarizer layer having a first major surface and a second major surface. A prism layer is disposed on the first major surface. A matte layer is disposed on the second major surface, the matte layer comprising a plurality of microstructures having a slope distribution, wherein a HWHM of the slope distribution is not greater than about 6 to about degrees, the matte layer, when adjacent a smooth surface, providing a coefficient of friction between the optical film and the smooth surface of less than about 1.

Another embodiment involves an optical film having a polarizer layer with a first major surface and a second major surface. A prism layer disposed on the first major surface and a matte layer is disposed on the second major surface, the matte layer having a plurality of microstructures, wherein a coefficient of friction between the matte layer and a smooth surface is less than about 1.

A further embodiment is directed to an optical film stack. A first optical film has a first major surface and a second major surface, the second major surface comprising a plurality of microstructures. A second optical film has a third major surface and a fourth major surface, the third major surface of the second optical film oriented toward the second major surface of the first optical film, wherein the optical film stack warps less than an identical optical film stack with out the plurality of microstructures.

Yet another embodiment is directed to a backlight including a light source and a diffuser. A first optical film includes a first base layer having a first major surface, a second major surface, and a plurality of edges, a first prism layer disposed on the first major surface of the first base layer, a first matte layer disposed on the second major surface of the first base layer, the matte layer the comprising microstructures. A second optical film includes a second base layer having a first major surface and a second major surface and a second prism layer disposed on the first major surface of the second base layer, the prism layer of the second optical film oriented toward the first matte layer and the second major surface of the second base layer oriented toward the diffuser, wherein the first optical film is constrained at the edges and the coefficient of friction between the first optical film and the second optical film is less than 1.

### BRIEF DESCRIPTION OF DRAWINGS

FIG. 1 is a schematic side-view of optical film stack that includes an optical film with a matte surface;

FIG. 2A is a schematic side-view of an optical film stack that includes a top optical film, having a microstructured top surface and a matte bottom surface, and a bottom optical film;

FIG. 2B is an optical film stack that includes crossed prism films, the top film having a matte surface;

FIG. 3 is an optical film having a prism layer on the top and a matte surface on the bottom;

FIG. 4 is a schematic side-view of a cutting tool system 400 that can be used to fabricate a tool having a pattern which can be microreplicated to produce microstructures;

FIGS. 5A-5D are cutters that can be used to make microstructures in accordance with embodiments of the invention;

FIGS. 6-8 are micrographs of matte surface patterns that can be fabricated using the process described in connection with FIG. 4;

FIGS. 9A-9B illustrate a system configured to make matte surfaces in accordance with embodiments of the invention;

FIGS. 10A-10B are micrographs of a microstructured surface fabricated using the process depicted in FIGS. 9A-9B;

FIG. 11 is a side view of a microstructure;

FIGS. 12-13 are side views of optical films;

FIG. 14 is a graph of calculated optical haze versus surface fraction, “f”;

FIG. 15 is a graph of calculated optical clarity versus surface fraction, “f”;

FIG. 16 is an AFM surface profile of a microstructured surface;

FIGS. 17A-17 B are cross sectional profiles of the microstructured surface of FIG. 16 along two mutually orthogonal directions;

FIG. 18 is a graph of the percent slope distribution for the microstructured surface of FIG. 16;

FIG. 19 is a graph of the height distribution for the microstructured surface of FIG. 16;

FIG. 20 is a graph of the percent slope magnitude distribution of the microstructured surface of FIG. 16;

FIG. 21 is a graph of the percent cumulative slope distribution of the microstructured surface of FIG. 16;

FIG. 22 are graphs of the percent cumulative slope distributions for various microstructured surfaces;

FIG. 23 is a schematic side-view of an optical system for measuring effective transmission;

FIG. 24 is a schematic side-view of a test set-up for visual warp testing;

FIGS. 25A-25B are side and top views, respectively, of the test configuration used to determine the warp Mura score;

FIG. 26 is a graph of visual warp score versus COF;

FIG. 27 is a graph of the warp “mura score” versus COF;

FIGS. 28-29 are statistical plots of the warp “mura score” for various optical films;

FIG. 30 illustrates the surface characterization of microreplicated matte surfaces for selected samples listed in TABLE 1;

FIG. 31 illustrates the surface characterization of matte surfaces made using the face-side roll process for selected samples form TABLE 4.

FIG. 32 is a schematic view of a display system.

### DETAILED DESCRIPTION

Optical films are used to condition light emitted from a light source such as by polarizing light and/or redirect light while at the same time masking and/or eliminating physical defects and/or optical defects. Physical defects may include warping and scratches and optical defects may include wetout, moiré and color mura, for example. Thinner displays are generally desirable, however, particularly when thin films are arranged into an optical film stack, the films and/or film stacks are susceptible to warping. A matte surface between adjacent thin films has been found to reduce the coefficient of friction (COF) between films and to reduce warping. The matte surfaces described herein also provide an optical haze that is sufficiently low to maintain brightness, and an optical clarity that is sufficiently low to provide defect masking. The matte surfaces described herein may be used in conjunction with polarizing layers, prism layers, diffusers, and/or other optical structures or layers.

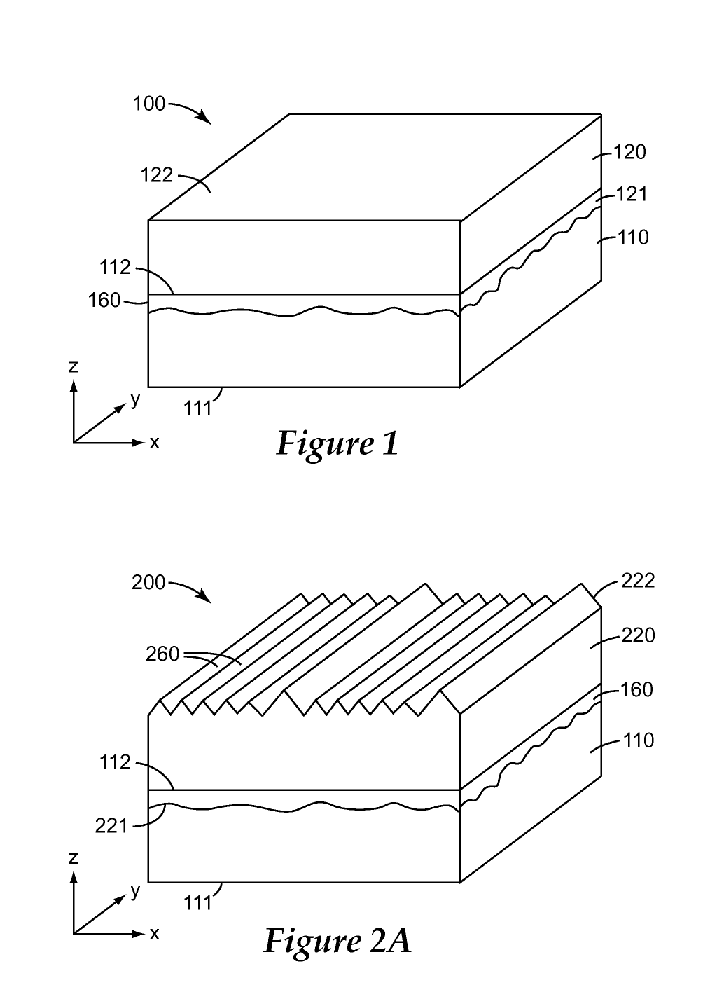

FIG. 1 is a schematic side-view of optical film stack 100 that includes an optical film 120 with a matte surface 121. The optical films 110, 120 in the optical film stack 100 are arranged so that the matte surface 121 is between the two optical films 110, 120 in the stack 100. The matte surface 121 comprises a plurality of microstructures 160 which are described more fully below. Optical film 110 includes a first major surface 111 and a second major surface 112 opposite the first major surface 111. Optical film 120 includes a first major surface 121, which is the matte surface, and a second major surface 122 opposite the first major surface 121. Matte surface 121 is adjacent to the second major surface 112 of optical film 110 in the optical film stack 100. The microstructures 160 of the matte surface 121 may be configured to achieve the coefficient of friction (COF), anti-warp properties, slope distribution, slope magnitude, haze and/or clarity properties described herein. Only optical film 120 is depicted with a matte surface 121 in FIG. 1, however, in some implementations, optical film 110 may include a matte bottom surface as well. The optical films 110, 120 may be multi-layer films.

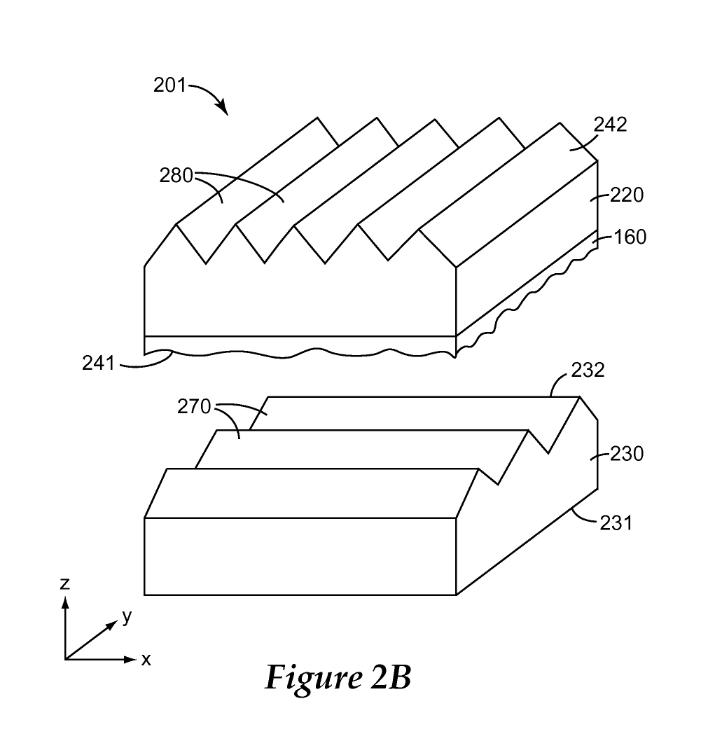

FIG. 2A is a schematic side-view of an optical film stack 200 that includes a light redirecting film 220. Light redirecting film 220 includes a first major surface 221 that is a matte surface comprising microstructures 160 and an opposing second major surface 222.

The second major surface 222 includes a plurality of light directing microstructures 260, such as the linear prisms depicted in FIG. 2A. The optical film stack includes optical film 110 as described in connection with FIG. 1. The optical stack 200 is arranged so that the matte surface, i.e., the first major surface 221 of the light redirecting film 220, is arranged adjacent to the second major surface 112 of optical film 110 in the optical film stack 200. The microstructures 160 of the matte surface 221 may be configured to achieve the coefficient of friction (COF), anti-warp properties, slope distribution, slope magnitude, haze and/or clarity properties described herein. In some applications, optical films 220, 110 may be fabricated as multi-layer structures. For example, optical film 220 may be fabricated as a prism layer and/or a matte layer disposed on a base layer. One or more of the layers, e.g., the base layer may comprise multiple layers.

In some applications, it is beneficial to include two light redirecting films in an optical stack. Each of the light redirecting films may include linear prisms with the films arranged so that the direction of the prisms of one of the films is at an angle with respect to the direction of the linear prisms of another of the films. Such an arrangement is illustrated in FIG. 2B. FIG. 2B illustrates crossed prism films 230, 240. The direction of the linear prisms 270 of film 230 may be at a 90 degree or other angle with respect to the direction of the linear prisms 280 of film 240. Film 230 includes a first major surface 231 and an opposing second major surface 232 that includes microstructures, such as the linear prisms 270 illustrated in FIG. 2B. The bottom major surface 231 of film 230 may also comprise a matte surface include microstructures similar to surface 241.

Light redirecting film 240 is similar to the film 220 illustrated in FIG. 2A. Film 240 includes a first major surface 241. Surface 241 includes microstructures 160. Opposing second major surface 242 includes microstructures depicted as linear prisms 280 in FIG. 2B. The first major surface 241, which is a matte surface, is arranged so that it is adjacent to the second major surface 232 of optical film 230 in the optical film stack 201. The microstructures 160 of the matte surface 241 may be configured to achieve the coefficient of friction (COF), anti-warp properties, slope distribution, slope magnitude, haze and/or clarity properties described herein. In some applications, optical films 230, 240 may be fabricated as multi-layer structures. For example, either or both of optical films 230, 230 may be fabricated as a prism layer and/or a matte layer disposed on a base layer. One or more of the layers, e.g., the base layer, may comprise multiple layers.

In some cases, such as when optical stack 201 is included in the backlight of a liquid crystal display, linear microstructures 280 and/or 270 can give rise to moiré. In some cases, the two light redirecting films, and in particular, the top light redirecting film, can give rise to color mura. Color mura is due to the index dispersion of the light redirecting films. The first order color mura is typically visible close to the viewing angle limit of the light redirecting film while higher order color mura are typically visible at higher angles. In some cases, such as when major surfaces 241 and 231 have sufficiently low optical haze and clarity, the optical stack can effectively mask or eliminate moiré and color mura without significantly reducing the display brightness. In such cases, each of the major surfaces 241, 231 has an optical haze that is not greater than about 5%, or not greater than about 4.5%, or not greater than about 4%, or not greater than about 3.5%, or not greater than about 3%, or not greater than about 2.5%, or not greater than about 2%, or not greater than about 1.5%, or not greater than about 1%; and each of the major surfaces 241, 231 has an optical clarity that is not greater than about 85%, or not greater than about 80%, or not greater than about 75%, or not greater than about 70%, or not greater than about 65%, or not greater than about 60%.

In some cases, such as when optical stack 201 is used in a display system to increase the brightness, the average effective transmission (ETA) of the optical stack is not less than about 2.4, or not less than about 2.45, or not less than about 2.5, or not less than about 2.55, or not less than about 2.6, or not less than about 2.65, or not less than about 2.7, or not less than about 2.75, or not less than about 2.8. In some cases, both surfaces 231 and 241 are matte surfaces, and the average effective transmission of optical stack 201 is less by no more than about 1%, or about 0.75%, or about 0.5%, or about 0.25%, or about 0.1%, as compared to an optical stack that has the same construction (including material composition) except for comprising smooth bottom major surfaces. In some cases, both bottom major surfaces 231 and 241 comprise matte surfaces, and the average effective transmission of optical stack 201 is not less as compared to an optical stack that has the same construction except for having smooth bottom major surfaces. In some cases, both bottom major surfaces 241 and 231 comprise matte surfaces, and the average effective transmission of optical stack 201 is greater by at least about 0.1%, or about 0.2%, or about 0.3%, as compared to an optical stack that has the same construction except for comprising smooth bottom major surfaces. As an example, an optical stack was fabricated that was similar to optical stack 201 with surfaces 241, 231 comprising matte surfaces with microstructures, and the optical stack had an average effective transmission of about 2.773. Each of respective major surfaces 231, 241 had an optical haze of about 1.5% and an optical clarity of about 83%. The linear prisms had an index of refraction of about 1.65. For comparison, a similar optical stack that had the same construction except for including smooth major surfaces, had an average effective transmission of about 2.763. Hence, the structured bottom major surfaces 231, 241 provided additional again by increasing the average effective transmission by about 0.36%.

As another example, an optical stack was fabricated that was similar to optical stack 201 with matte bottom major surfaces 241, 231 and had an average effective transmission of about 2.556. Each of respective major surfaces 241, 231 had an optical haze of about 1.29% and an optical clarity of about 86.4%. The linear prisms had a pitch of about 24 microns, an apex angle of about 90 degrees, and an index of refraction of about 1.567. For comparison, a similar optical stack that had the same construction except for including smooth bottom major surfaces, had an average effective transmission of about 2.552. Hence, the structured bottom major surfaces 241, 231 provided additional gain by increasing the average effective transmission by about 0.16%.

As yet another example, an optical stack was fabricated that was similar to optical stack 201 with matte bottom major surfaces 241, 231 and had an average effective transmission of about 2.415. Each of respective bottom major surfaces 241, 231 had an optical haze of about 1.32% and an optical clarity of about 84.8%. The linear prisms had a pitch of about 24 microns, an apex angle of about 90 degrees, and an index of refraction of about 1.567. For comparison, a similar optical stack that had the same construction except for including smooth bottom major surfaces, had an average effective transmission of about 2.404. Hence, the structured bottom major surfaces 241, 231 provided additional again by increasing the average effective transmission by about 0.46%.

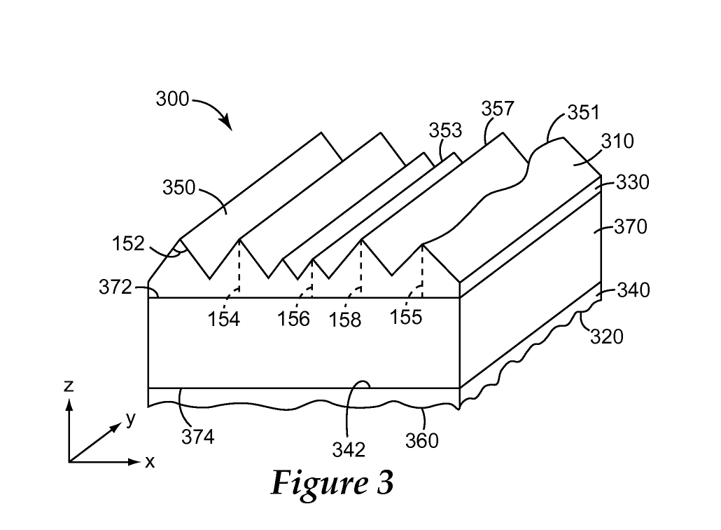

FIG. 3 is a schematic side-view of an optical film 300. The exemplary optical film 300 includes three layers 330, 370 and 340. In general, the optical film 300 can have one or more layers. For example, in some cases, the optical film can have a single layer that includes respective first and second major surfaces 310 and 320. As another example, in some cases, the optical film can have many layers. For example, in such cases, base layer 370 can have multiple layers.

The total thickness of the optical film 300 may range down to about 40 microns, or microns or even down to 30 microns, with the thickness of the prism layer 330 ranging down to 12 microns or 8 microns, the thickness of the base layer 370 ranging down to 30 microns or 25 microns or 20 microns and the thickness of the matte layer ranging down to 5 microns or 3 microns or less than about 2 microns.

Film 300 includes a first major surface 310 that includes a plurality of microstructures 350 that extend along the y-direction. Film 300 also includes a second major surface 320 that is opposite first major surface 310 and includes a plurality of microstructures 360.

Film 300 also includes a base layer 370 that is disposed between respective first and second major surfaces 310 and 320 and includes a first major surface 372 and an opposing second major surface 374. Film 300 also includes a prism layer 330 that is disposed on first major surface 372 of the base layer 370 and includes first major surface 310 of the film, and a matte layer 340 that is disposed on second major surface 374 of the base layer 370 and includes second major surface 320 of the film 300. The matte layer 340 has a major surface 342 opposite major surface 320.

Microstructures 350 may be designed primarily to redirect light that is incident on the major surface 320 of the optical film 300 along a desired direction, such as along the positive z-direction. In the exemplary optical film 300, microstructures 350 are prismatic linear structures. In general, microstructures 350 can be any type microstructures that are capable of redirecting light by, for example, refracting a portion of an incident light and recycling a different portion of the incident light. For example, the cross-sectional profiles of microstructures 350 can be or include curved and/or piece-wise linear portions. For example, in some cases, microstructures 350 can be linear cylindrical lenses extending along the y-direction.

Each linear prismatic microstructure 350 includes an apex angle 152 and a height 154 measured from a common reference plane 372. In some cases, such as when it is desirable to reduce optical coupling or wet-out and/or improve durability of the light redirecting film, the height of a prismatic microstructure 150 can change along the y-direction. For example, the prism height of prismatic linear microstructure 151 varies along the y-direction. In such cases, prismatic microstructure 151 has a local height that varies along the y-direction, a maximum height 155, and an average height. In some cases, a prismatic linear microstructure, such as linear microstructure 153, has a constant height along the y-direction. In such cases, the microstructure has a constant local height that is equal to the maximum height and the average height.

In some cases, such as when it is desirable to reduce optical coupling or wet-out, some of the linear microstructures are shorter and some of the linear microstructures are taller. For example, height 156 of linear microstructure 153 is smaller than height 158 of linear microstructure 157.

Apex or dihedral angle 152 can have any value that may be desirable in an application. For example, in some cases, apex angle 152 can be in a range from about 70 degrees to about 110 degrees, or from about 80 degrees to about 100 degrees, or from about 85 degrees to about 95 degrees. In some cases, microstructures 150 have equal apex angles which can, for example, be in a range from about 88 or 89 degree to about 92 or 91 degrees, such as 90 degrees.

Prism layer 330 can have any index of refraction that may be desirable in an application. For example, in some cases, the index of refraction of the prism layer is in a range from about 1.4 to about 1.8, or from about 1.5 to about 1.8, or from about 1.5 to about 1.7. In some cases, the index of refraction of the prism layer is not less than about 1.5, or not less than about 1.55, or not less than about 1.6, or not less than about 1.65, or not less than about 1.7.

Base layer 370 can be or include any material that may be suitable in an application, such as a dielectric, a semiconductor, or a metal. For example, base layer 370 can include or be made of glass and polymers such as polyethylene terephthalate (PET), polycarbonates, and acrylics. Base layer 370 can be rigid or flexible. Base layer 370 can have any thickness and/or index of refraction that may be desirable in an application. For example, in some cases, base layer 370 can be PET and have a thickness of about 23 microns, or about 50 microns or about 175 microns.

Base layer 370 may comprise a light polarizing layer, such as a reflective polarizer. Display light sources typically produce unpolarized light which is polarized before being directed to a liquid crystal (LC) matrix. An absorbing polarizer polarizes the light directed to the LC matrix by transmitting only a one polarization state and absorbing light of the other polarization state. A reflecting polarizer, however, may be used to reflect the light that would otherwise be absorbed, and so this light may be recycled. At least some of the light reflected by the reflecting polarizer may be depolarized, and subsequently returned to the reflecting polarizer in a polarization state that is transmitted through the reflecting polarizer to the LC layer. In this manner, the reflecting polarizer may be used to increase the fraction of light emitted by the light source that reaches the LC matrix.

Any suitable type of reflective polarizer may be used, for example, multilayer optical film (MOF) reflective polarizers; diffusely reflective polarizing film (DRPF), such as continuous/disperse phase polarizers or cholesteric reflective polarizers.

The MOF, cholesteric and continuous/disperse phase reflective polarizers all rely on varying the refractive index profile within a film, usually a polymeric film, to selectively reflect light of one polarization state while transmitting light in an orthogonal polarization state. Some examples of MOF reflective polarizers are described in U.S. Pat. No. 5,882,774, incorporated herein by reference. Commercially available examples of MOF reflective polarizers include Vikuiti™ DBEF-II and DBEF-D400, BEF-RP, multilayer reflective polarizers that include diffusive surfaces, available from 3M Company, St. Paul, Minn.

The recycling reflective polarizer described in U.S. Pat. No. 5,882,774 is a multilayer optical polarizing film where the alternating layers making up the film have refractive indices along a direction perpendicular to the film that are substantially matched, so that the reflectivity of any given interface in the film for p-polarized light is substantially constant as a function of incidence angle.

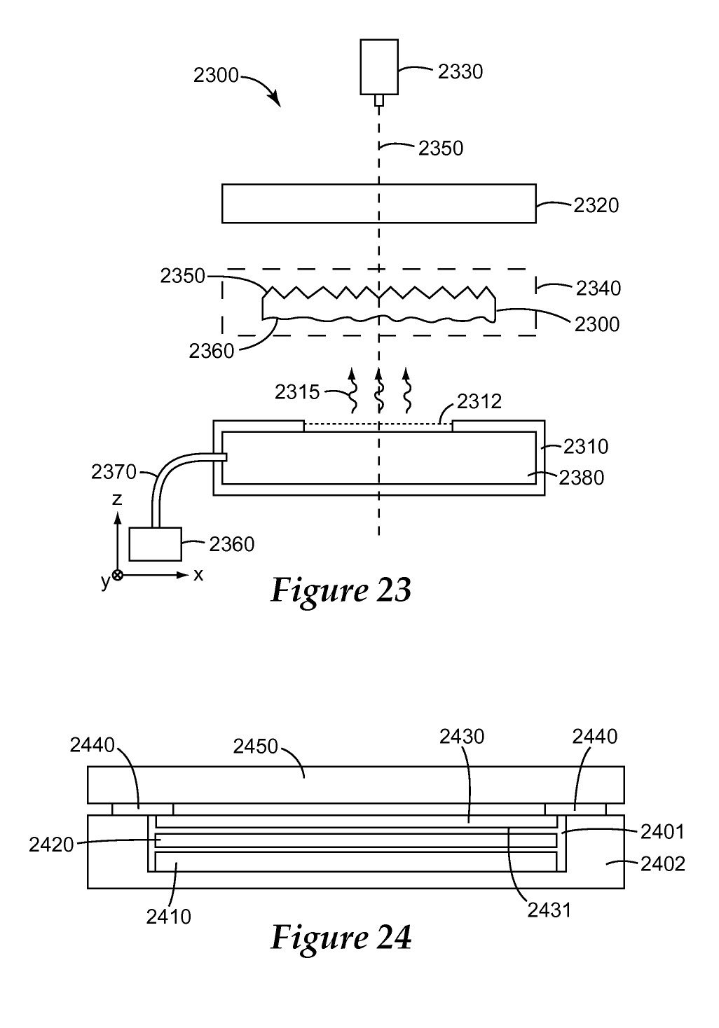

In some cases, such as when light redirecting film 300 is used in a liquid crystal display system, prism layer 330 of optical film 300 can serve to increase or improve the brightness of the display. In such cases, the film 300 has an effective transmission or relative gain that is greater than 1. As used herein, effective transmission is the ratio of the luminance of the display system with the film in place in the display system to the luminance of the display without the film in place. Measurement of average effective transmission (ETA) is described below in connection with FIG. 23. When film 300 is used in a display system as a brightness enhancement film to increase the brightness and the linear prisms have an index of refraction that is greater than about 1.6, the ETA of the film is not less than about 1.5, or not less than about 1.55, or not less than about 1.6, or not less than about 1.65, or not less than about 1.7, or not less than about 1.75, or not less than about 1.8, or not less than about 1.85. When the film is used as a reflective polarizer and for brightness enhancement, the ETA of the film is not less than 2, or not less than 2.2, or not less than 2.5.

Layer 340 includes microstructures 360 that provide a matte surface. The matte layer 340 decreases the coefficient of friction (COF) between optical film 300 and an adjacent layer in an optical film stack. Reducing the COF between thin layers allows the two adjacent layers to move relative to one another without binding, for example, during expansion and/or contraction of the layers due to variation in temperature and/or humidity. The matte layer in accordance with the embodiments disclosed herein may be designed to provide enhanced warp characteristics by decreasing the COF between adjacent layers to less than about 1, or less than about 0.8, or less than about 0.6 while also providing the desired haze, clarity, and/or ETA characteristics. When the matte surfaces described herein are tested on a smooth surface, the COF is reduced when compared to the COF between two smooth surfaces.

Microstructures 360 in matte layer 340 may also hide undesirable physical defects (such as, for example, scratches) and/or optical defects (such as, for example, undesirably bright or “hot” spots from a lamp in a display or illumination system) with no, or very little adverse, effect on the capabilities of the light redirecting film to redirect light and enhance brightness. In such cases, second major surface 320 has an optical haze that is not greater than about 5%, or not greater than about 4.5%, or not greater than about 4%, or not greater than about 3.5%, or not greater than about 3%, or not greater than about 2.5%, or not greater than about 2%, or not greater than about 1.5%, or not greater than about 1%; and an optical clarity that is not greater than about 85%, or not greater than about 80%, or not greater than about 75%, or not greater than about 70%, or not greater than about 65%, or not greater than about 60%.

Optical haze, as used herein, is defined as the ratio of the transmitted light that deviates from the normal direction by more than 4 degrees to the total transmitted light. Haze values disclosed herein were measured using a Haze-Gard Plus haze meter (available from BYK-Gardiner, Silver Springs, Md.) according to the procedure described in ASTM D1003. Optical clarity, as used herein, refers to the ratio (T₁−T₂)/(T₁+T₂), where T₁ is the transmitted light that deviates from the normal direction between 1.6 and 2 degrees from the normal direction, and T₂ is the transmitted light that lies between zero and 0.7 degrees from the normal direction. Clarity values disclosed herein were measured using a Haze-Gard Plus haze meter from BYK-Gardiner.

Microstructures 360 can be any type microstructures that may be desirable in an application. For example, microstructures 360 may form a regular pattern, an irregular patter, a random pattern, or a pseudo-random pattern that appears to be random.

Microstructures 360 can be made using any suitable fabrication method. For example, the matte layer 340 having microstructures 360 may be formed by coating a substance on the base layer 370. The coating substance may include particles that form the microstructures. Coating methods include die coating, dip coating, roll coating, extrusion coating, extrusion replication and/or other coating processes.

The microstructures 360 can be fabricated using microreplication from a tool, where the tool may be fabricated using any available fabrication method, such as by using engraving or diamond turning. Exemplary diamond turning systems and methods can include and utilize a fast tool servo (FST) as described in, for example, PCT Published Application No. WO 00/48037, and U.S. Pat. Nos. 7,350,442 and 7,328,638, the disclosures of which are incorporated in their entireties herein by reference thereto.

The COF of the matte surface may be dependent on the geometry of the structures that form the matte surface and may depend on the glass transition temperature, Tg. To achieve COF values less than 1, the material selected to form the matte surface may have a Tg less than about 100 C, or less than about 90 C, or less than about 80 C, or less than about 70 C.

Matte surfaces may be formed using the face-side roller process described herein and as further described in 2009/0029054 incorporated herein by reference. As previously described, the COF of the matte surface is dependent on the geometry of the structures that form the matte surface and the transition temperature, Tg. Surfactant additives to the base coating resin modify the surface chemistry of the coating and also contribute to the COF for films fabricated using the face-side roller process.

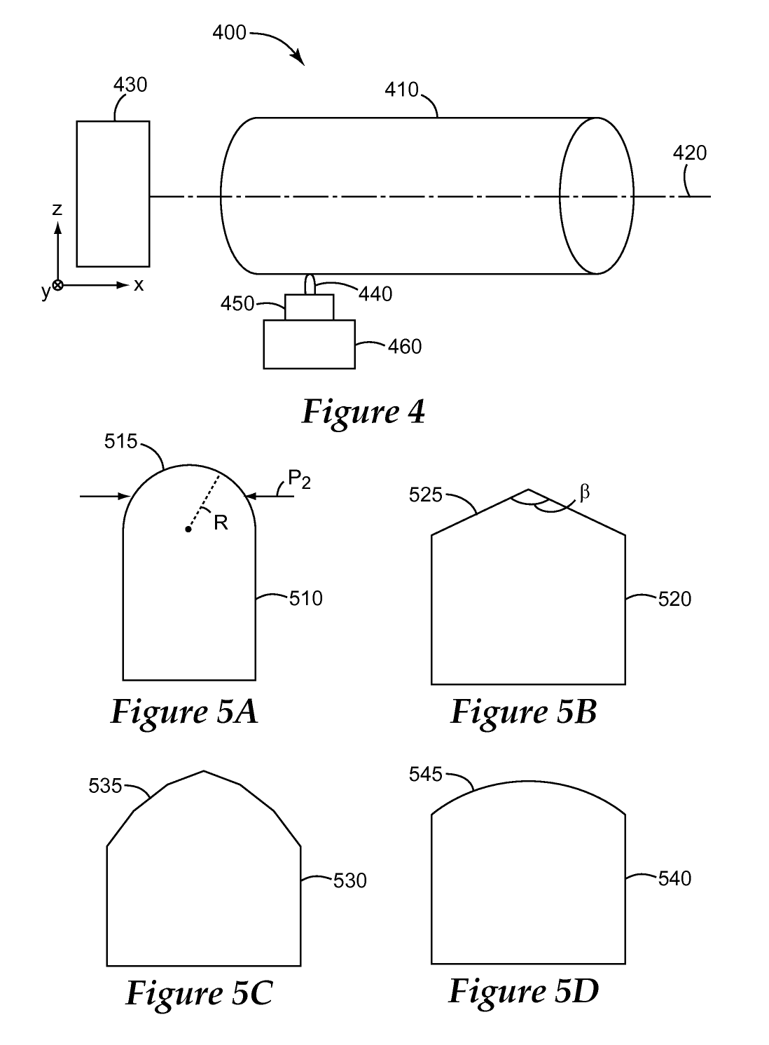

FIG. 4 is a schematic side-view of a cutting tool system 400 that can be used to fabricate a tool having a pattern which can be microreplicated to produce microstructures 360. Cutting tool system 400 employs a thread cut lathe turning process and includes a roll 410 that can rotate around and/or move along a central axis 420 by a driver 430, and a cutter 440 for cutting the roll material. The cutter is mounted on a servo 450 and can be moved into and/or along the roll along the x-direction by a driver 460. In general, cutter 440 is mounted normal to the roll and central axis 420 and is driven into the engraveable material of roll 410 while the roll is rotating around the central axis. The cutter is then driven parallel to the central axis to produce a thread cut. Cutter 440 can be simultaneously actuated at high frequencies and low displacements to produce features in the roll that, when microreplicated, result in microstructures 360.

Servo 450 is a fast tool servo (FTS) and includes a solid state piezoelectric (PZT) device, often referred to as a PZT stack, which rapidly adjusts the position of cutter 440. FTS 450 allows for highly precise and high speed movement of cutter 440 in the x-, y- and/or z-directions, or in an off-axis direction. Servo 450 can be any high quality displacement servo capable of producing controlled movement with respect to a rest position. In some cases, servo 450 can reliably and repeatably provide displacements in a range from 0 to about 20 microns with about 0.1 micron or better resolution.

Driver 460 can move cutter 440 along the x-direction parallel to central axis 420. In some cases, the displacement resolution of driver 1060 is better than about 0.1 microns, or better than about 0.01 microns. Rotary movements produced by driver 430 are synchronized with translational movements produced by driver 460 to accurately control the resulting shapes of microstructures 360.

The engraveable material of roll 410 can be any material that is capable of being engraved by cutter 440. Exemplary roll materials include metals such as copper, various polymers, and various glass materials.

Cutter 440 can be any type of cutter and can have any shape that may be desirable in an application. For example, FIG. 5A is a schematic side-view of a cutter 510 that has an arc-shape cutting tip 515 with a radius “R”. In some cases, the radius R of cutting tip 515 is at least about 100 microns, or at least about 150 microns, or at least about 200 microns, or at least about 300 microns, or at least about 400 microns, or at least about 500 microns, or at least about 1000 microns, or at least about 1500 microns, or at least about 2000 microns, or at least about 2500 microns, or at least about 3000 microns.

As another example, FIG. 5B is a schematic side-view of a cutter 520 that has a V-shape cutting tip 525 with an apex angle R. In some cases, the apex angle 13 of cutting tip 525 is at least about 100 degrees, or at least about 110 degrees, or at least about 120 degrees, or at least about 130 degrees, or at least about 140 degrees, or at least about 150 degrees, or at least about 160 degrees, or at least about 170 degrees. As yet other examples, FIG. 5C is a schematic side-view of a cutter 530 that has a piece-wise linear cutting tip 535, and FIG. 5D is a schematic side-view of a cutter 540 that has a curved cutting tip 545.

Referring back to FIG. 4, the rotation of roll 410 along central axis 420 and the movement of cutter 440 along the x-direction while cutting the roll material defines a thread path around the roll that has a pitch P₁ along the central axis. As cutter moves along a direction normal to the roll surface to cut the roll material, the width of the material cut by the cutter changes as the cutter moves or plunges in and out. Referring to, for example FIG. 5A, the maximum penetration depth by the cutter corresponds to a maximum width P₂ cut by the cutter.

The prism layer 330 of optical film 300 may be made using a similar process to the process described in connection with FIG. 4. Separate tools, i.e., a matte tool and a prism tool, may be produced to make the matte layer 340 and the prism layer 330, respectively. After fabrication of the tools, the matte tool and the prism tool may be used to form the optical film using the base layer 370 as the substrate. In a first pass, the major surface 374 of the base layer 370 may formed using the matte tool to form the matte layer 340. In a second pass, the opposite major surface 342 of the base layer 370 may be formed using the prism tool.

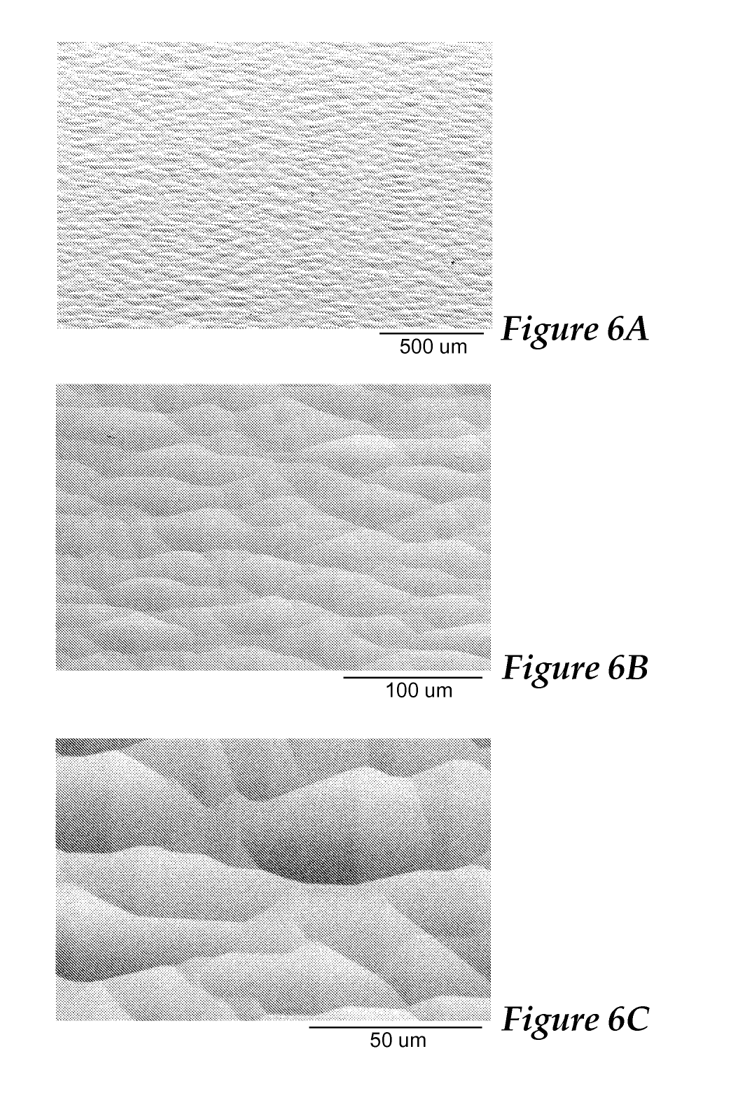

FIGS. 6-8 are micrographs of matte surface patterns that can be fabricated using the process described in connection with FIG. 4. FIGS. 6A-6C are top-view scanning electron micrographs (SEMs) of a sample at three different magnifications. The sample of FIGS. 6A-6C was made using a cutter similar to cutter 520 where the apex angle of the cutting tip 525 was about 176 degrees. The sample was geometrically symmetric. Using confocal microscopy, the average height of the microstructures was measured to be about 2.67 microns.

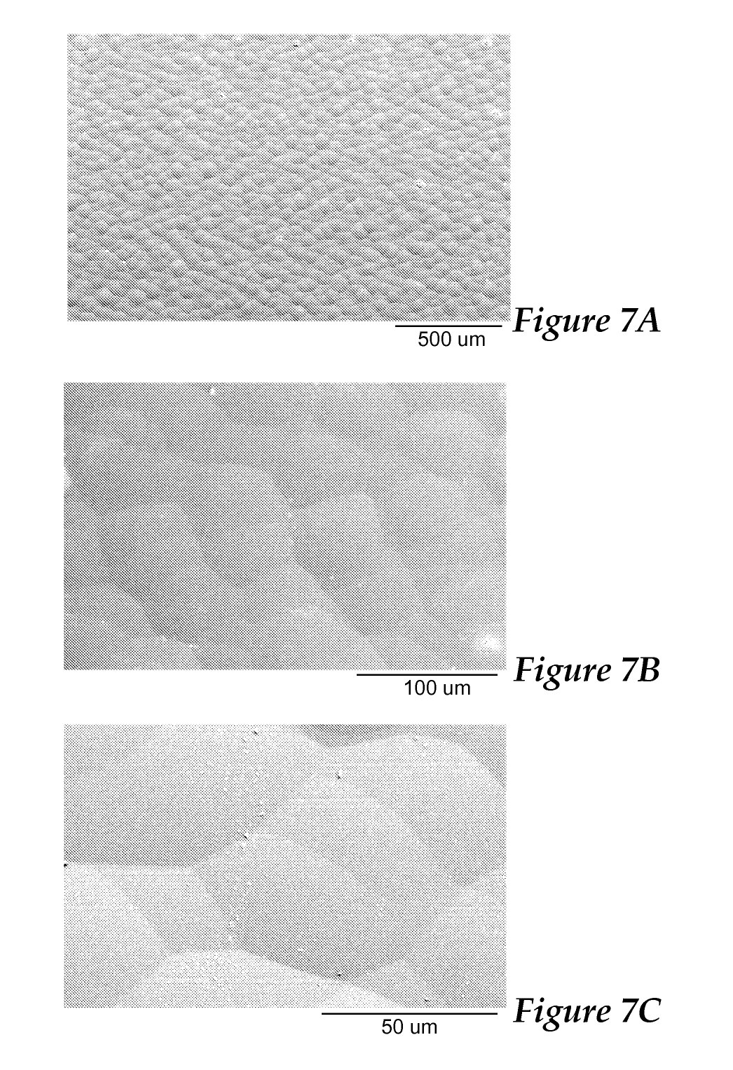

FIGS. 7A-7C are top-view SEMs of a sample at three different magnifications. The sample was made using a cutter similar to cutter 510 where the radius of the cutting tip 515 was about 480 microns. The sample was geometrically symmetric. Using confocal microscopy, the average height of the microstructures was measured to be about 2.56 microns.

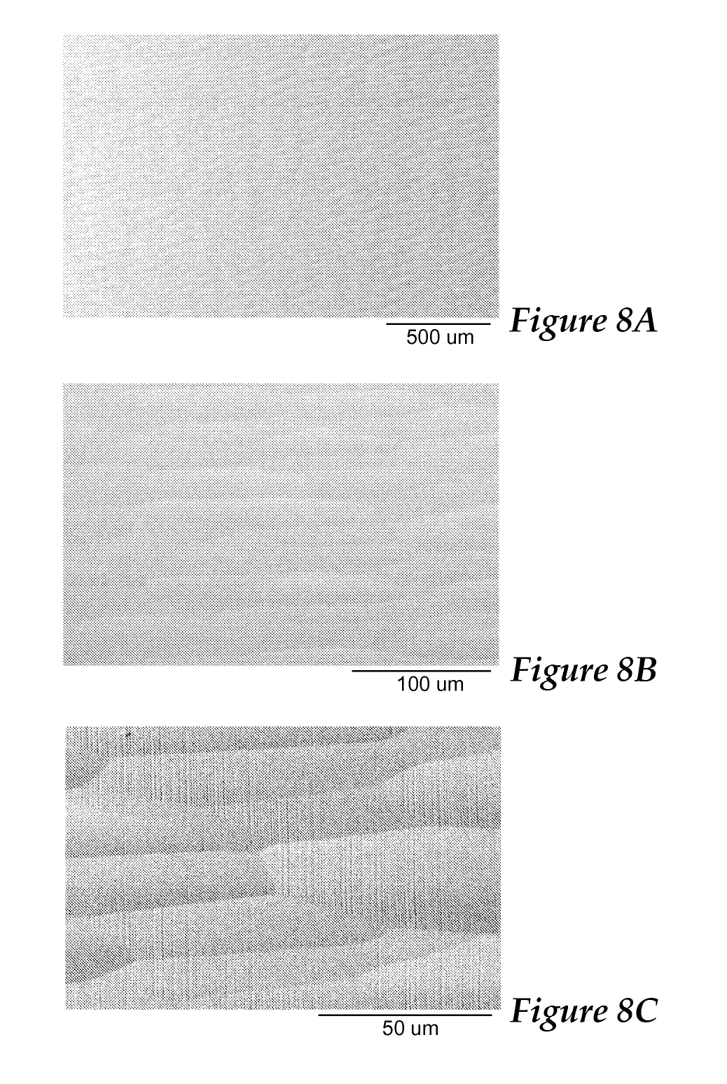

FIGS. 8A-8C are top-view SEMs of a sample at three different magnifications. The sample was made using a cutter similar to cutter 510 where the radius of the cutting tip 515 was about 3300 microns. The sample was geometrically asymmetric. Using confocal microscopy, the average height of the microstructures was measured to be about 1.46 microns.

Alternative processes for forming the matte layer 340 do not involve a patterned tool. An example of one such process is described in commonly owned U.S. Patent Publication 2009/0029054 which is previously incorporated herein by reference. In this process, a material coated on a substrate is treated to change the viscosity of the coatable material from a first or initial viscosity to a second viscosity. Once the viscosity of the coatable material is at a second viscosity, the material is then subjected to face-side pressure to impart a matte finish thereon. With its matte finish, the coatable material may optionally be further hardened, cured or solidified.

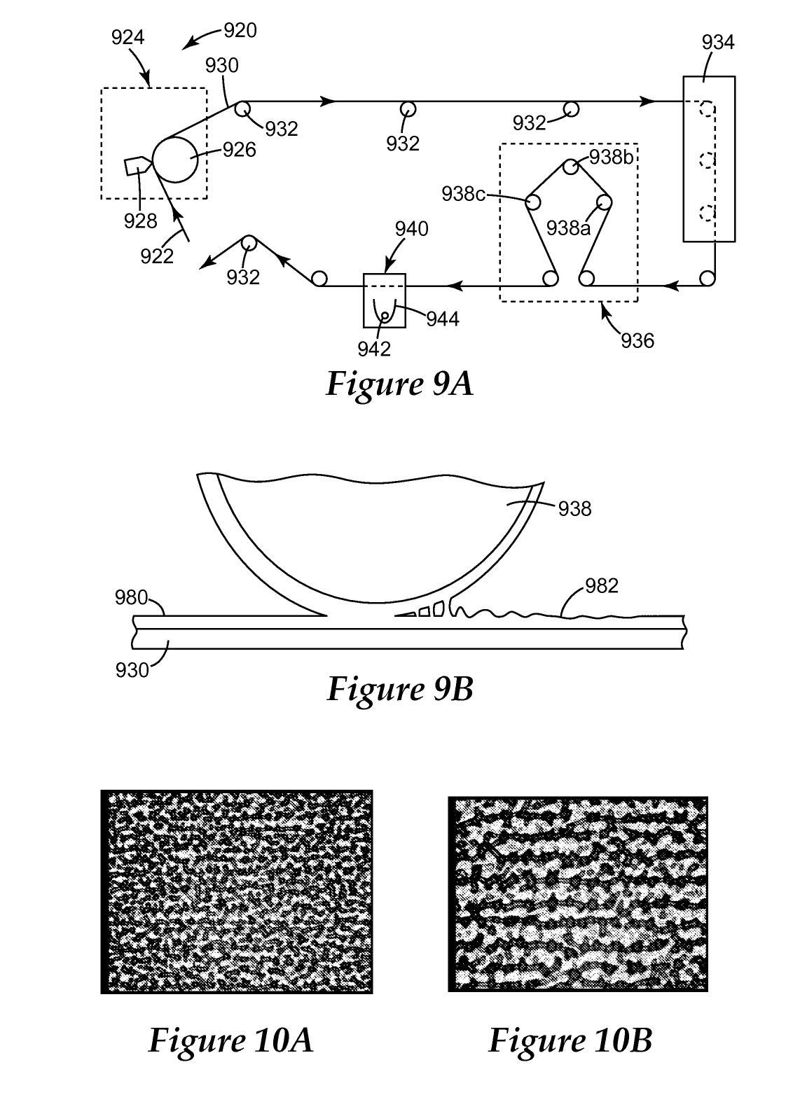

FIG. 9A is a diagram of a system capable of making matte layer 340. An uncoated substrate 922, e.g., base layer 370, is conveyed to a first station 924 in an uncoated state, though it may be primed on at least one surface. The substrate is moved to the first station 924 by back-up roll 926 and idle rolls 932. At station 924, a coatable material is deposited on the uncoated substrate 922 by coating mechanism 928 to produce a coated substrate 930. In the embodiment shown in FIG. 9A, substrate 922 is depicted as a continuous or uncut material. In other embodiments, the substrate may be provided in a discontinuous form or in individual pieces (e.g., pre-cut or pre-made to suit a specific application).

At the time of deposition by the coating mechanism 926, the coatable material may have an initial viscosity that is lower than a second viscosity. Alternatively, the coatable material may have an initial viscosity that is higher than a second viscosity.

In embodiments of the invention, the coatable material, when first applied to the substrate, is typically liquid or gel-like and is flowable or spreadable so as to form a liquid or gel-like film of material on a major surface of the substrate 922. The coatable material may comprise at least one curable component.

In some embodiments, the coatable material includes at least one solvent and the coatable material is applied directly to the substrate 922. In other embodiments, the coatable material may be solvent-less (e.g., 100% solids) and the coatable material may be applied to a roller and then transferred to the substrate 922.

Second station 934 provides means for changing the viscosity of the coatable material. In the depicted embodiment, second station 934 increases the viscosity of the coatable material. In embodiments in which the coatable material includes at least one solvent, the coatable material may be exposed to a heat source such as an oven, a heating element or the like wherein the coatable material is subjected to elevated temperatures sufficient to drive off solvent and/or partially cure at least one component in the coatable material. While in the second station 934, the viscosity of the coatable material is raised to a second or higher viscosity to render the coatable material sufficiently hardened, dried and/or cured to endure further processing, as is described herein. The exact temperature of the second station 934 will depend, in part, on the composition of the coatable material, the desired viscosity of the coatable material after it exits the second station 934 and the amount of time a coated substrate dwells within the station 934.

Alternatively, at station 934, the viscosity of the coatable material may be decreased from the initial viscosity, e.g., by application of heat to soften the coatable material, or may be increased from the initial viscosity. e.g., by cooling the coatable material, and/or by partial curing of the coatable material. In some implementations, the coatable material may not require either heating or cooling to attain an acceptable second viscosity. For some coatable materials, exposure of the coated substrate 930 in air under ambient conditions may be sufficient to harden or soften the coatable material to permit further processing, as described herein.

The substrate 930 is conveyed from second station 934 to third station 936 where the coatable material on the substrate 930 directly contacts one or more face-side rollers 938. In the embodiment shown in FIG. 9A, face-side rollers comprise three rollers 938a, 938b, 938c. More or fewer face-side rollers may be used. Coated substrate 930 is maintained in sufficient tension around face-side rollers 938 to generate a matte finish on the substrate 930.

A matte surface is not formed by imprinting a pattern on the surface of the face-side rollers to the coatable material. Rather, it is believed that the matte surface is formed by the interaction of the coatable material and the unremarkable surface of the face-side rollers. This process is illustrated in FIG. 9B. The coatable material 980 is of sufficient tack that a portion of the coatable material adheres to the surface of the face-side roller 938. At this point in the process, the coatable material 980 has been subjected to conditions at the second station 934 so that the coatable material 980 is cohesive and resistant to flow and will not excessively transfer to the surface of face-side roller 938 or deform when pressed against the face-side roller 938. However, the outermost layer of the coatable material, adheres to the face-side roller 938, and then releases therefrom to create a matte surface 982 on the substrate 930 that can be viewed in detail under magnification.

Not wishing to be bound by any theory, in some embodiments, a small volume of coatable material may initially adhere to a face-side roller 938. A steady-state condition is typically achieved as coatable material is continually released from the face-side roller 938 at nearly the same rate at which coatable material is picked up by the face-side roller. In other words, an incoming segment of the coated substrate 930 includes coatable material that contacts a face-side roller that has been pre-wetted with the same coatable material from an upstream segment of the coated substrate. As the segment of coatable material contacts the face-side roller, it picks up some of the coatable material already deposited on the roller. As the same segment of coated substrate departs the face-side roll, a portion of the surface layer of the coatable material on the coated substrate splits away so that some of the coatable material remains on the face-side roller while a net amount of coatable material remaining on the substrate is, on average, equal to the amount of the coatable material incoming to the face-side roll.

The coated substrate 930 exits the third station 936 with a matte surface finish imparted to the surface by the face-side rollers 938. An optional fourth station 940 may be used to further harden or cure the coatable material. The fourth station 940 is optional in that the coatable material may not require such a treatment.

Either before or after the formation of the matte surface, prism films may be microreplicated on the base layer.

FIGS. 10A and 10B are micrograph images of a portion of a matte surface made using the face-side roller process described in connection with FIG. 9. In this particular film, the matte layer has a thickness of about 2 microns on top of the substrate. FIG. 10A is at a magnification of 50× and FIG. 10B is the same surface at a magnification of 125×.

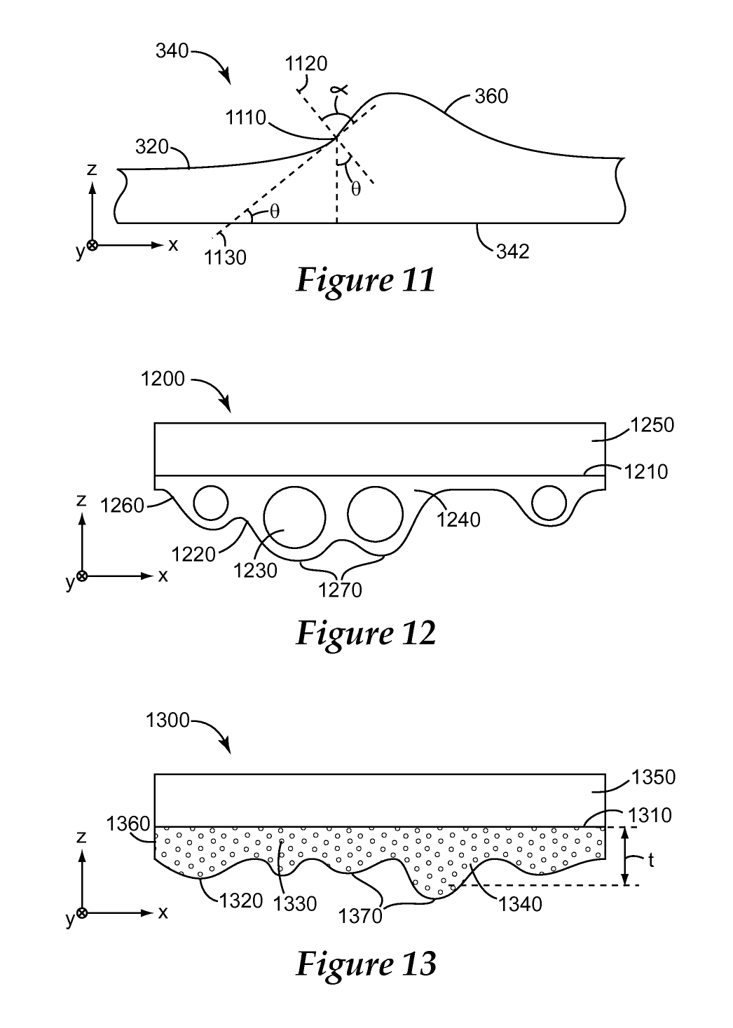

FIG. 11 is a schematic side view of a portion of matte layer 340 (FIG. 3) that may be formed, for example, using the processes described above. In particular, FIG. 11 shows a microstructure 360 in major surface 320 and facing major surface 342. Microstructure 360 has a slope distribution across the surface of the microstructure. For example, the microstructure has a slope θ at a location 1110 where θ is the angle between normal line 1120 which is perpendicular to the microstructure surface at location 1110 (α=90 degrees) and tangent line 1530 which is tangent to the microstructure surface at the same location. Slope θ is also the angle between tangent line 1130 and major surface 342 of the matte layer.

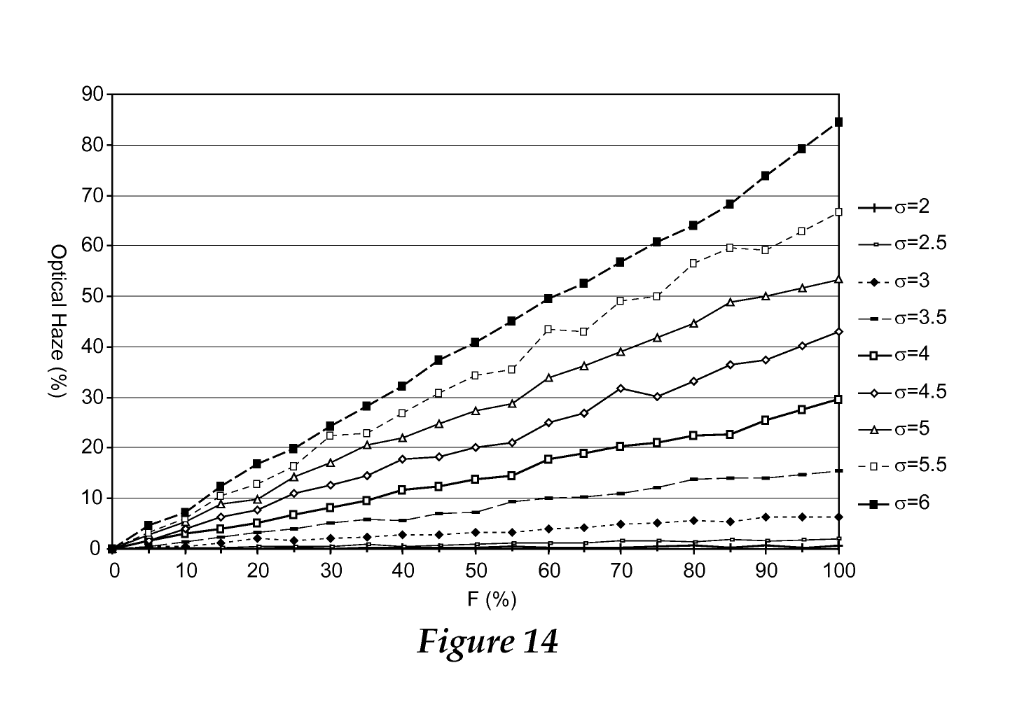

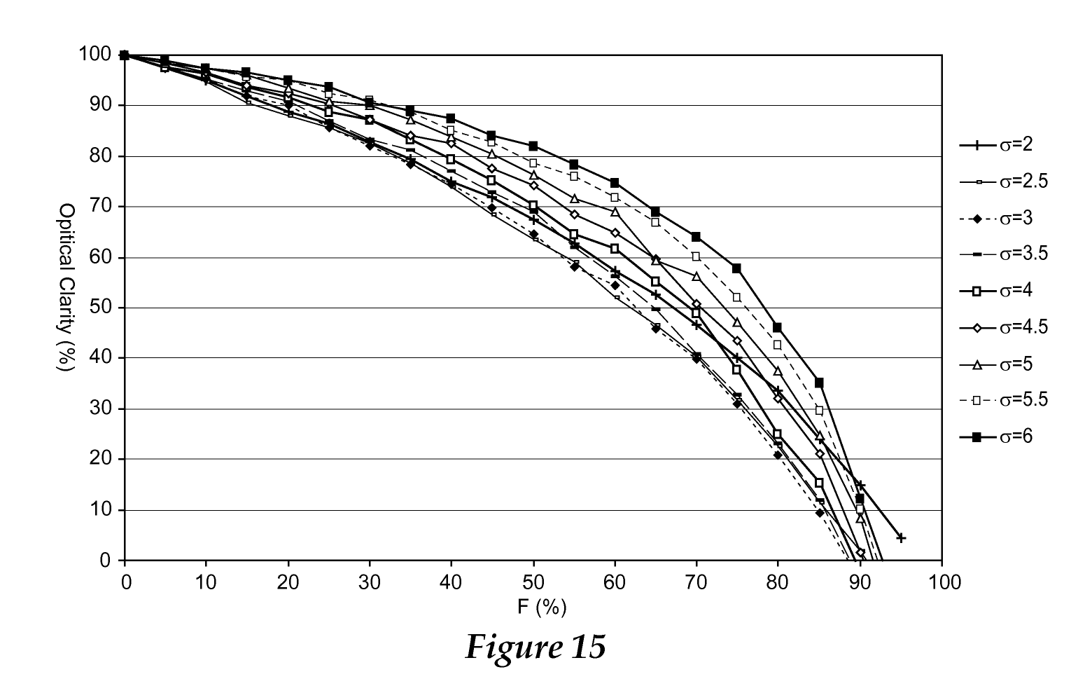

Optical haze and clarity of matte layer 340 were calculated using a program that was similar to commercially available ray tracing programs such as, for example, TracePro (available from Lambda Research Corp., Littleton, Mass.). In carrying out the calculations, it was assumed that each microstructure had a Gaussian slope distribution with a half width at half maximum (HWHM) equal to σ. It was further assumed that the matte layer had an index of refraction equal to 1.5. The calculated results are shown in FIGS. 14 and 15. FIG. 14 is the calculated optical haze versus surface fraction “f” for nine different values of σ, where f is percent area of major surface 320 covered by microstructures 360. FIG. 15 is the calculated optical clarity versus f. In some cases, such as when microstructures 360 effectively hide physical and/or optical defects without reducing or minimally reducing the brightness, the plurality of microstructures 360 covers at least about 70%, or at least about 75%, or at least about 80%, or at least about 85%, or at least about 90%, or at least about 95%, of second major surface 320. In some cases, such as when the microstructures have a Gaussian or normal slope distribution, the HWHM a of the distribution is not greater than about 4.5 degrees, or not greater than about 4 degrees, or not greater than about 3.5 degrees, or not greater than about 3 degrees, or not greater than about 2.5 degrees, or not greater than about 2 degrees.

In the exemplary calculations disclosed above, it was assumed that microstructures 360 have a Gaussian slope distribution with a HWHM equal to a. In general, the microstructures can have any distribution that may be desirable in an application. For example, in some cases, such as when the microstructures are spherical segments, the microstructures can have a uniform distribution between two limiting angles. Other exemplary slope distributions include Lorentzian distributions, parabolic distributions, and combinations of different, such as Gaussian, distributions. For example, in some cases, the microstructures can have a first Gaussian distribution with a smaller HWHM σ₁ added to, or combined with, a second Gaussian distribution with a larger HWHM σ₂. In some cases, the microstructures can have asymmetric slope distributions. In some cases, the microstructures can have symmetric distributions.

FIG. 12 is a schematic side-view of an optical film 1200 that includes a matte layer 1260 disposed on a substrate 1250 similar to base layer 370. Matte layer 1260 includes a first major surface 1210 attached to substrate 1250, a second major surface 1220 opposite the first major surface, and a plurality of particles 1230 dispersed in a binder 1240. Second major surface 1220 includes a plurality of microstructures 1270. A substantial portion, such as at least about 50%, or at least about 60%, or at least about 70%, or at least about 80%, or at least about 90%, of microstructures 1270 are disposed on and formed primarily because of particles 1230. In other words, particles 1230 are the primary reason for the formation of microstructures 1270. In such cases, particles 1230 have an average size that is greater than about 0.25 microns, or greater than about 0.5 microns, or greater than about 0.75 microns, or greater than about 1 micron, or greater than about 1.25 microns, or greater than about 1.5 microns, or greater than about 1.75 microns, or greater than about 2 microns.

In some cases, matte layer 340 can be similar to matte layer 1260 and can include a plurality of particles that are the primary reason for the formation of microstructures 360 in second major surface 320. Particles 1230 can be any type particles that may be desirable in an application. For example, particles 1230 may be made of polymethyl methacrylate (PMMA), polystyrene (PS), or any other material that may be desirable in an application. In general, the index of refraction of particles 1230 is different than the index of refraction of binder 1240, although in some cases, they may have the same refractive indices. For example, particles 1230 can have an index of refraction of about 1.35, or about 1.48, or about 1.49, or about 1.50, and binder 1240 can have an index of refraction of about 1.48, or about 1.49, or about 1.50.

In some cases, matte layer 340 does not include particles. In some cases, matte layer 340 includes particles, but the particles are not the primary reason for the formation of microstructures 360. For example, FIG. 13 is a schematic side-view of an optical film 1300 that includes a matte layer 1360 similar to matter layer 340 disposed on a substrate 1350 similar to substrate 370. Matte layer 1360 includes a first major surface 1310 attached to substrate 1350, a second major surface 1320 opposite the first major surface, and a plurality of particles 1330 dispersed in a binder 1340. Second major surface 1370 includes a plurality of microstructures 1370. Even though matte layer 1360 includes particles 1330, the particles are not the primary reason for the formation of microstructures 1370.

For example, in some cases, the particles are much smaller than the average size of the microstructures. In such cases, the microstructures can be formed by, for example, microreplicating a structured tool or a face-side roller. In such cases, the average size of particles 1330 is less than about 0.5 microns, or less than about 0.4 microns, or less than about 0.3 microns, or less than about 0.2 microns, or less than about 0.1 microns. In such cases, a substantial fraction, such as at least about 50%, or at least about 60%, or at least about 70%, or at least about 80%, or at least about 90%, of microstructures 970 are not disposed on particles that have an average size that is greater than about 0.5 microns, or greater than about 0.75 microns, or greater than about 1 micron, or greater than about 1.25 microns, or greater than about 1.5 microns, or greater than about 1.75 microns, or greater than about 2 microns. In some cases, the average size of particles 1330 is less than the average size of microstructures 1330 by at least a factor of about 2, or at least a factor of about 3, or at least a factor of about 4, or at least a factor of about 5, or at least a factor of about 6, or at least a factor of about 7, or at least a factor of about 8, or at least a factor of about 9, or at least a factor of about 10.

In some cases, if matte layer 1360 includes particles 1330, then matte layer 1360 has an average thickness “t” that is greater than the average size of the particles by at least about 0.5 microns, or at least about 1 micron, or at least about 1.5 microns, or at least about 2 microns, or at least about 2.5 microns, or at least about 3 microns. In some cases, if the matte layer includes a plurality of particles then the average thickness of the matte layer is greater than the average thickness of the particles by at least a factor of about 2, or at least a factor of about 3, or at least a factor of about 4, or at least a factor of about 5, or at least a factor of about 6, or at least a factor of about 7, or at least a factor of about 8, or at least a factor of about 9, or at least a factor of about 10.

Again referring back to FIG. 3, in some cases, light redirecting film 300 has small particles in at least some of the layers, such as prism layer 330, base layer 370, or matte layer 340, for increasing the index of refraction of the layer. For example, one or more layers in light redirecting film 300 can include inorganic nanoparticles such as silica or zirconia nanoparticles discussed in, for example U.S. Pat. No. 7,074,463 (Jones et al.) and U.S. Patent Publication No. 2006/0210726. In some cases, light redirecting film 300 does not include any particles having an average size that is greater than about 2 microns, or about 1.5 microns, or about 1 micron, or about 0.75 microns, or about 0.5 microns, or about 0.25 microns, or about 0.2 microns, or about 0.15 microns, or about 0.1 microns.

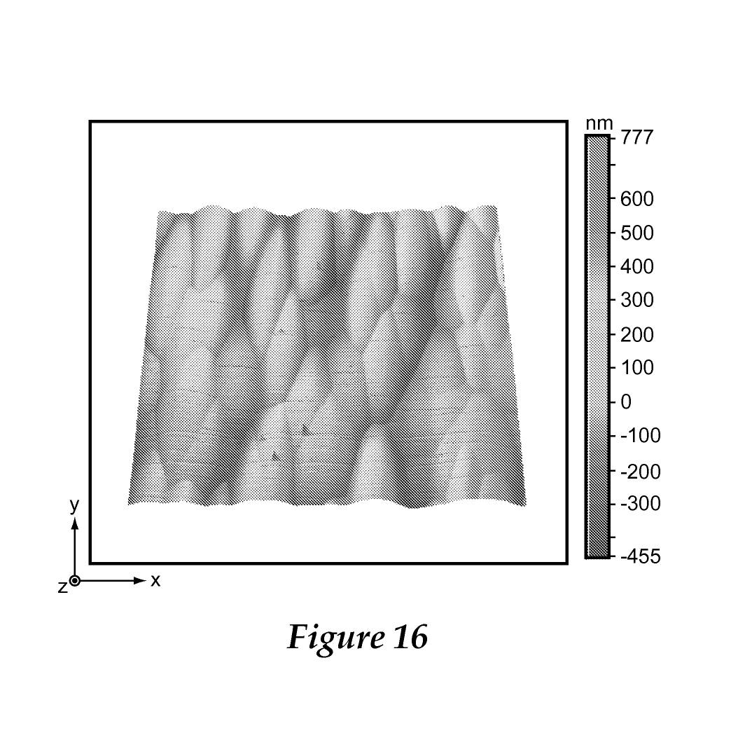

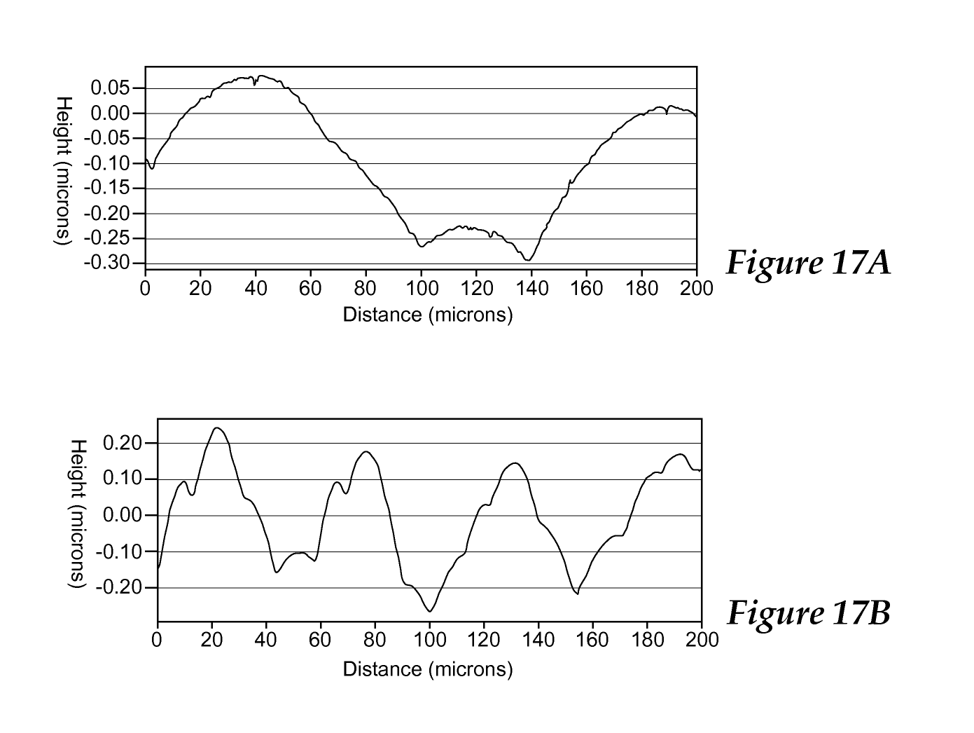

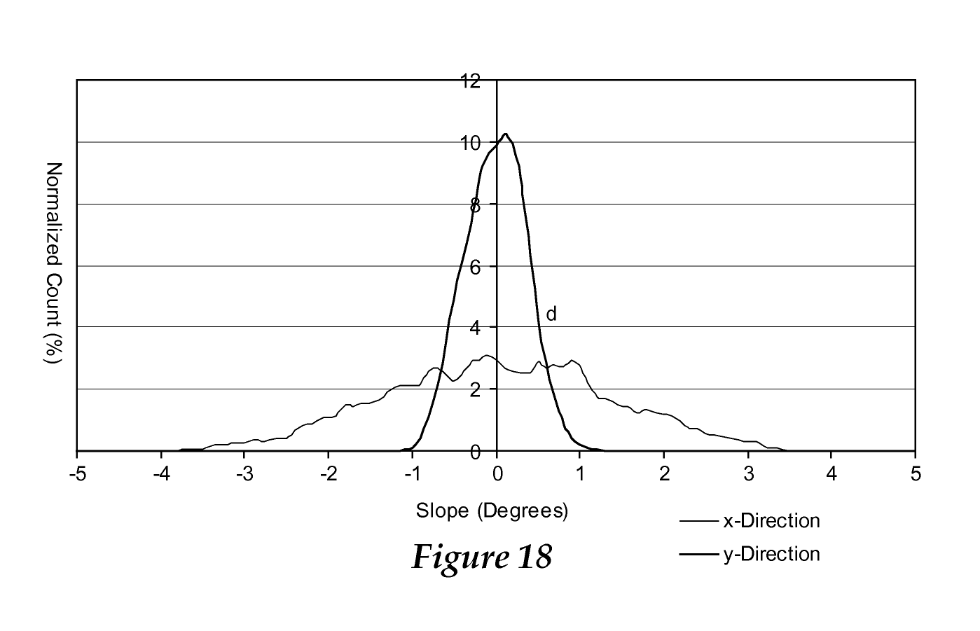

The surfaces of a number of samples were characterized over an area of about 200 microns by about 200 microns using atomic force microscopy (AFM). FIG. 16 is an exemplary AFM surface profile of one such sample, labeled sample A. The sample had an optical transmission of about 94.9%, an optical haze of about 1.73%, and an optical clarity of about 79.5%. FIGS. 17A and 17B are exemplary cross-sectional profiles of sample A along the x- and y-directions, respectively. FIG. 18 shows the percent slope distribution along the x- and y-directions for sample A. Slopes Sₓ and S_{y} along respective x- and y-directions were calculated from the following two expressions:

Sₓ=∂H(x,y)/∂x (1)

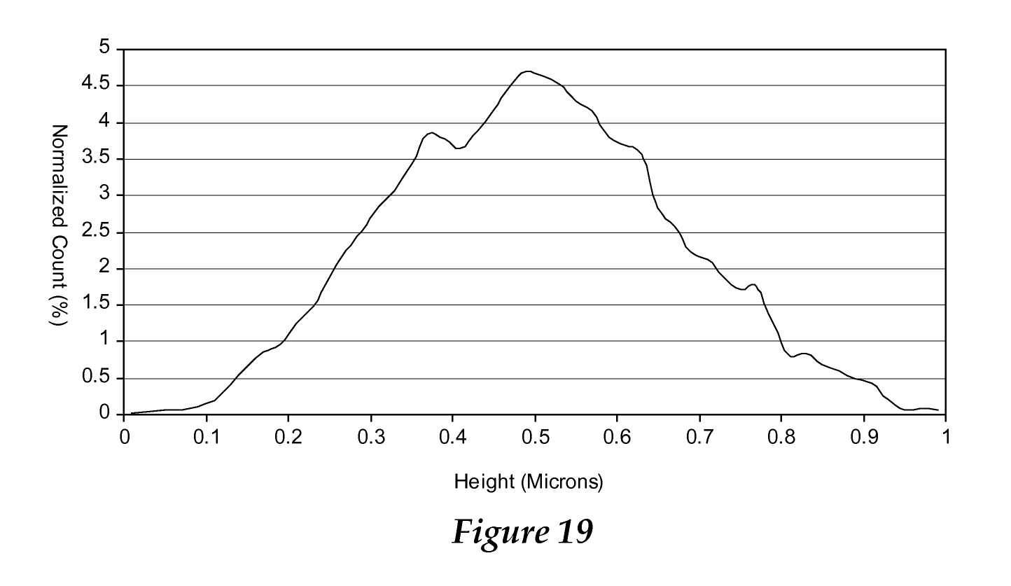

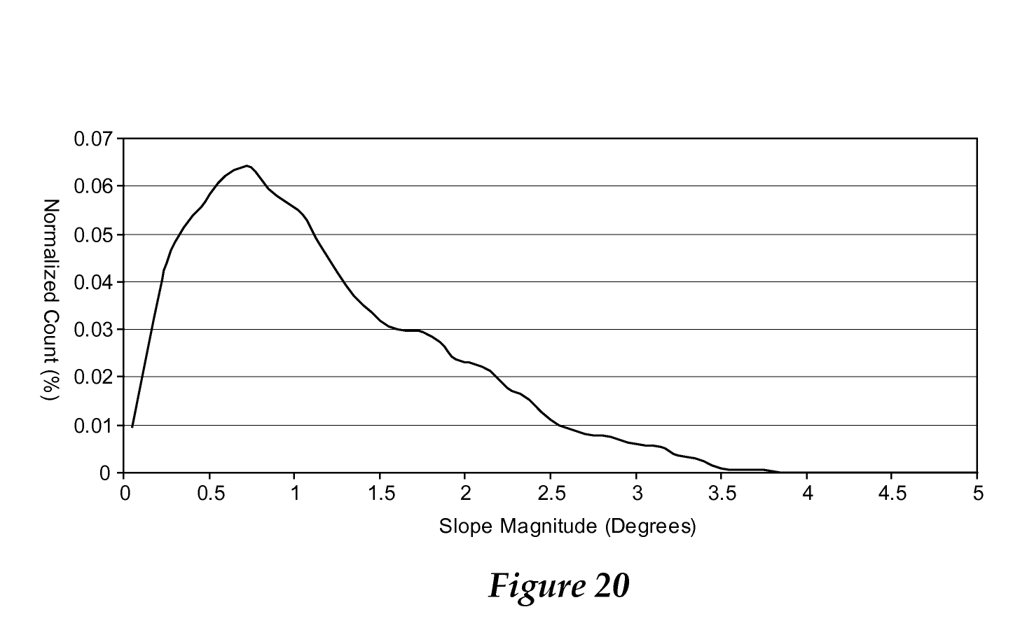

S_{y}=∂H(x,y)/∂y (2)

where H(x,y) is the surface profile. The slopes Sₓ and S_{y} were calculated using a slope bin size of 0.5 degrees. As is evident from FIG. 18, sample A had a symmetric slope distribution along both the x- and the y-directions. Sample A had a broader slope distribution along the x-direction and a narrower slope distribution along the y-direction. FIG. 19 shows the percent height distribution across the analyzed surface for sample A. As is evident from FIG. 19, the sample had a substantially symmetric height distribution relative to the peak height of the sample which was about 4.7 microns. FIG. 20 shows the percent slope magnitude for sample A, where the slope magnitude Sₘ was calculated from the following expression:

Sₘ=\sqrt{[∂H/∂x]²+[∂H/∂y]²} (3)

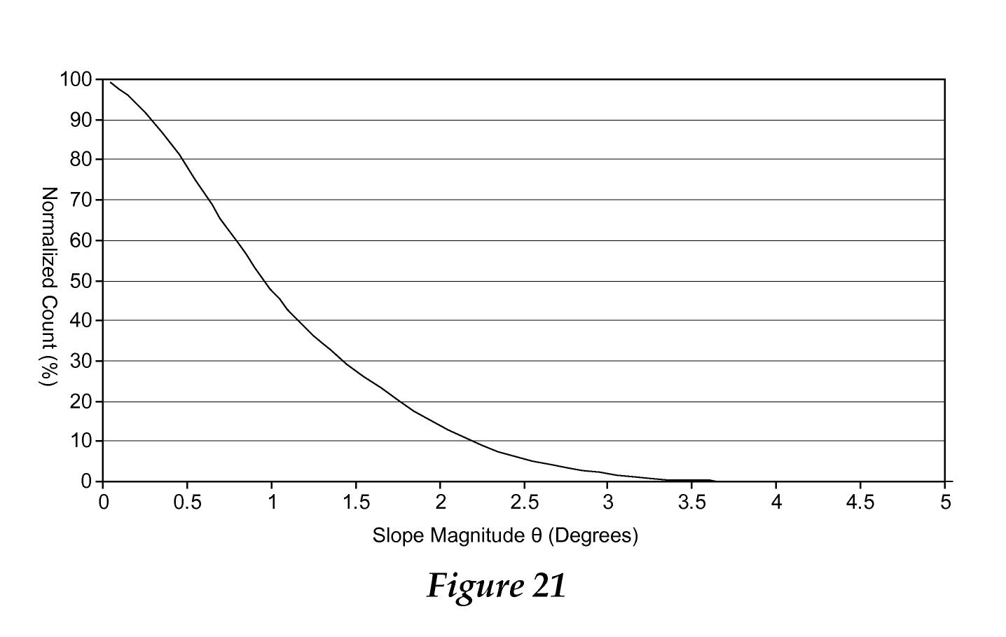

FIG. 21 shows the percent cumulative slope distribution S_{c}(θ) for sample A, where S_{c}(θ) was calculated from the following expression:

$${S}_{c} ( θ ) = \frac{{\int }_{θ}^{∞} {S}_{m} }{{\int }_{0}^{∞} {S}_{m}} \qquad ( 4 )$$

As is evident from FIG. 21, about 100% of the surface of sample A had a slope magnitude less than about 3.5 degrees. Furthermore, about 52% of the analyzed surface had slope magnitudes less than about 1 degree, and about 72% of the analyzed surface had slope magnitudes less than about 1.5 degrees.

Three additional samples similar to sample A, and labeled B, C, and D, were characterized as previously outlined. All four samples A-D had microstructures similar to microstructures 360 and were made using a cutting tool system similar to cutting tool system 400 to make a patterned roll using a cutter similar to cutter 520 and subsequently microreplicating the patterned tool to make matte layers similar to matter layer 340. Sample B had an optical transmittance of about 95.2%, an optical haze of about 3.28% and an optical clarity of about 78%; Sample C had an optical transmittance of about 94.9%, an optical haze of about 2.12%, and an optical clarity of about 86.1%; and sample D had an optical transmittance of about 94.6%, an optical haze of about 1.71%, and an optical clarity of about 84.8%. In addition, six comparative samples, labeled R1-R6, were characterized. Samples R1-R3 were similar to matte layer 1260 and included a plurality of large beads dispersed in a binder, where the matte surfaces were primarily formed because of the beads. Sample R1 had an optical haze of about 17.8% and an optical clarity of about 48.5%, sample R2 (available from Dai Nippon Printing Co., Ltd.) had an optical haze of about 32.2% and an optical clarity of about 67.2%, and sample R3 had an optical haze of about 4.7% and an optical clarity of about 73.3%. Sample R4 was an embossed polycarbonate film (available from Keiwa Inc., Osaka, Japan) and had an optical haze of about 23.2% and an optical clarity of about 39.5%.

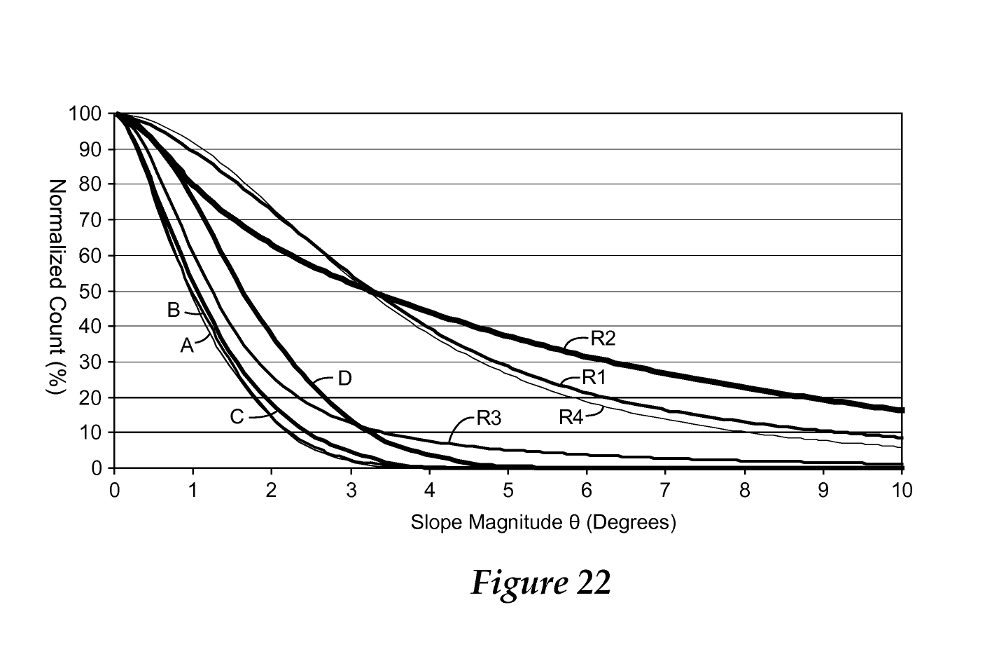

FIG. 22 is the percent cumulative slope distribution S_{c}(θ) for samples A-D and R1-R4. Each of samples A-D was similar to matte layer 340 and included a structured major surface similar to structured major surface 320. As evident from FIG. 22, no more than about 7%, or about 6.5%, or about 6%, or about 5.5%, or about 5%, or about 4.5%, or about 4%, or about 3.5%, or about 3%, of the structured major surfaces of all, or at least some, of the samples A-D had a slope magnitude greater than about 3.5 degrees. Furthermore, no more than about 4%, or about 3.5%, or about 3%, or about 2.5%, or about 2%, or about 1.5%, or about 1%, or about 0.9%, or about 0.8%, of the structured major surfaces of all, or at least some, of the samples A-D had a cumulative slope magnitude greater than about 5 degrees.

Referring back to FIG. 3, when used in an optical system such as in a liquid crystal display optical film 300 is capable of hiding or masking optical and/or physical defects of the display and enhancing the brightness of the display. In some cases, the average effective transmission of light redirecting film 300 is less by no more than about 2%, or by no more than about 1.5%, or by no more than about 1%, or by no more than about 0.75%, or by no more than about 0.5%, as compared to a light redirecting film that has the same construction as light redirecting film 300, except for having a smooth second major surface 320. In some cases, the average effective transmission of the light redirecting film is greater than by no less than about 0.2%, or about 0.3%, or about 0.4%, or about 0.5%, or about 1%, or about 1.5%, or about 2%, ac compared to a light redirecting film that has the same construction, except for having a smooth second major surface. As an example, a light redirecting film was fabricated that was similar to light redirecting film 300. Linear prisms 350 had a pitch of about 24 microns, an apex angle 152 of about 90 degrees, and index of refraction of about 1.65. Second major surface 320 had an optical haze of about 1.5% and an optical clarity of about 83%. The light redirecting film had an average effective transmission of about 1.803. For comparison, a similar light redirecting film that had the same construction (including material composition) except for comprising a smooth second major surface, had an average effective transmission of about 1.813.

As another example, a light redirecting film was fabricated that was similar to light redirecting film 300. Microstructures 360 were made by replication from a tool that was cut with a cutter similar to cutter 510 where the radius of cutter tip 515 was about 3300 microns. Linear prisms 350 had a pitch of about 24 microns, an apex angle 152 of about 90 degrees, and index of refraction of about 1.567. Second major surface 320 had an optical haze of about 1.71% and an optical clarity of about 84.8%. The light redirecting film had an average effective transmission of about 1.633. For comparison, a similar light redirecting film that had the same construction (including material composition) except for comprising a smooth second major surface, had an average effective transmission of about 1.626. Hence, the structured second major surface 320 provided additional gain by increasing the average effective transmission by about 0.43%.

As another example, a light redirecting film was fabricated that was similar to light redirecting film 300. Microstructures 360 were made by replication from a tool that was cut with a cutter similar to cutter 510 where the radius of cutter tip 515 was about 4400 microns. Linear prisms 350 had a pitch of about 24 microns, an apex angle 152 of about 90 degrees, and index of refraction of about 1.567. Second major surface 320 had an optical haze of about 1.49% and an optical clarity of about 82.7%. The light redirecting film had an average effective transmission of about 1.583. For comparison, a similar light redirecting film that had the same construction (including material composition) except for comprising a smooth second major surface, had an average effective transmission of about 1.578. Hence, the structured second major surface 320 provided additional gain by increasing the average effective transmission by about 0.32%.

As yet another example, a light redirecting film was fabricated that was similar to light redirecting film 300. Microstructures 360 were made by replication from a tool that was cut with a cutter similar to cutter 510 where the radius of cutter tip 515 was about 3300 microns. Linear prisms 150 had a pitch of about 24 microns, an apex angle 152 of about 90 degrees, and index of refraction of about 1.567. Second major surface 120 had an optical haze of about 1.35% and an optical clarity of about 85.7%. The light redirecting film had an average effective transmission of about 1.631. For comparison, a similar light redirecting film that had the same construction (including material composition) except for comprising a smooth second major surface, had an average effective transmission of about 1.593. Hence, the structured second major surface 320 provided additional gain by increasing the average effective transmission by about 2.38%.

Effective transmission (ET) can be measured using optical system 2300, a schematic side-view of which is shown in FIG. 23. Optical system 2300 is centered on an optical axis 2350 and includes a hollow lambertian light box that emits a lambertian light 2315 through an emitting or exit surface 2312, a linear light absorbing polarizer 2320, and a photo detector 2330. Light box 2310 is illuminated by a stabilized broadband light source 2360 that is connected to an interior 2380 of the light box via an optical fiber 2370. A test sample the ET of which is to be measured by the optical system, is placed at location 2340 between the light box and the absorbing linear polarizer.

The ET of light redirecting film 300 can be measured by placing the light redirecting film in location 2340 with linear prisms 350 facing the photo detector and microstructures 360 facing the light box. Next, the spectrally weighted axial luminance I₁ (luminance along optical axis 2350) is measured through the linear absorbing polarizer by the photo detector. Next, the light redirecting film is removed and the spectrally weighted luminance I₂ is measured without the light redirecting film placed at location 240. ET is the ratio I₁/I₂. ET0 is the effective transmission when linear prisms 350 extend along a direction that is parallel to the polarizing axis of linear absorbing polarizer 220, and ET90 is the effective transmission when linear prisms 350 extend along a direction that is perpendicular to the polarizing axis of the linear absorbing polarizer. The average effective transmission (ETA) is the average of ET0 and ET90.

Effective transmission values disclosed herein were measured using a SpectraScan™ PR-650 SpectraColorimeter (available from Photo Research, Inc, Chatsworth, Calif.) for photo detector 2330. Light box 2310 was a Teflon cube with a total reflectance of about 85%.

Optical film samples 1A-32A were prepared having dimensions of 51.4 mm×76.6 mm were fabricated and tested for COF. The samples were also arranged into optical stacks of two films and were visually assessed for warp following environmental testing at 65° C./95% relative humidity for 72 hours. The average mura index was measured and a mura score was determined for some of these samples as indicated below in Table 1.

COF values were measured using an IMASS 2000 (available from Imass, Inc., Accord, Mass.) using the following test parameters: speed 2.5 mm/sec, duration 10 sec, sled mass 200 g. A side view of the test set-up 2400 for visual warp testing is illustrated in FIG. 24. The optical film stack includes a diffuser film 2410 disposed in a well 2401 machined into a Plexiglas plate 2402. The bottom film 2420, having a thickness T2, was disposed on the diffuser film 2410. Various types of films were used as the bottom film 2420 as indicated by the column labeled “Bottom Film Type” in Table 1. The top film 2430, having a thickness T1, was constrained at the edges by rim tape 2440. A glass cover 2450 was arranged above the top film 2430. Various types of substrates were used in the top film 2430 as indicated by the column labeled “Top Film Type” in Table 1. The top films 2430 tested included a microreplicated matte surface (denoted MICRO in Table 1), or no matte surface (denoted NONE in Table 1), or a beaded matte surface (denoted BEAD in Table 1). The matte surface 2431 was oriented toward the bottom film. If a matte surface 2431 was present, the Tg for the matte surface material is indicated in Table 1. The COF was measured and the warp was assessed visually for each sample. Visual warp assessment involved comparing the appearance of warp following environmental testing to standard film stacks exhibiting varying degrees of warp ranging from severe warp to minimal warp. The test samples were rated as having severe warp, moderate warp, or minimal warp based on comparison of the test samples to the standard film stacks.

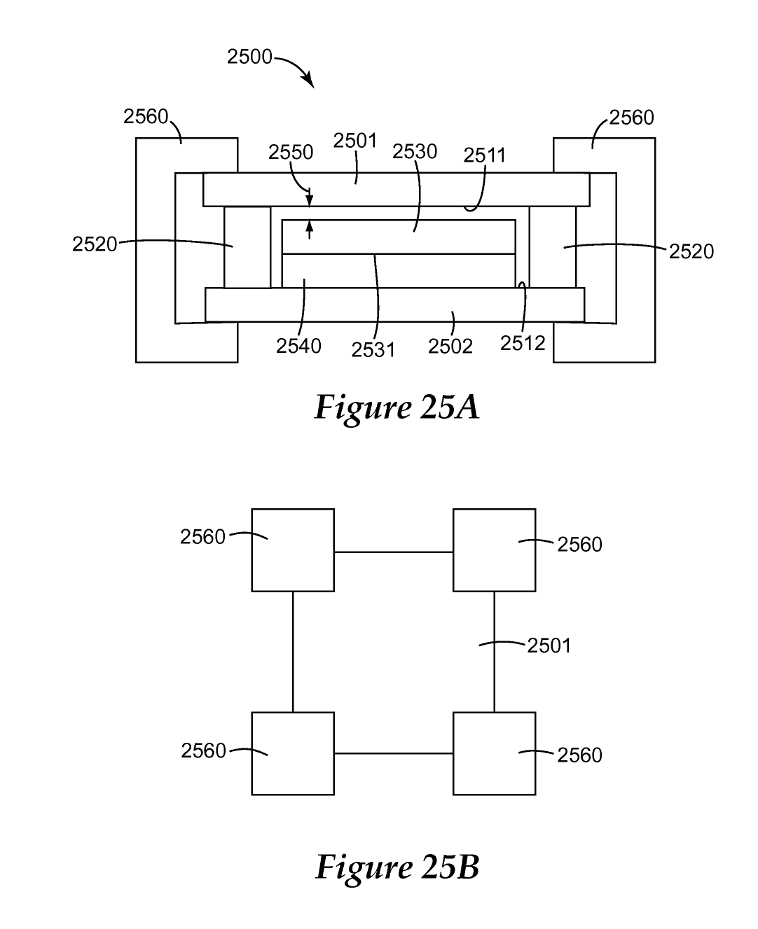

In addition to the visual assessment, a Mura score was determined for some of the sample film stack types as indicated in Table 1. A side view of the test configuration 2500 used to determine the Mura score is illustrated in FIG. 25A. The optical film stacks under test were disposed between top and bottom polycarbonate plates 2501, 2502 with matte surfaces, 2511, 2512. The bottom film 2540 was disposed on the bottom plate 2502. Spacers 2520 were used to maintain a 40 micron gap 2550 between the top film 2530 and the top plate 2501. The matte surface 2531 of the top film 2539 was oriented toward the bottom film 2540. The polycarbonate plates 2501, 2502 and spacers 2520 were compressed by clips 2560 at four corners as illustrated by the top view of the test configuration in FIG. 25B.

The Mura score was determined using the following process: After a two hour stabilization period following environmental testing, photographic images of the test optical film stacks were taken under room light at a polar angle 20 degrees, and azimuthal angles 1, 45, 90, 135, 180, 225, 270, 315 degrees. The photographic images were divided into a number of areas arranged as a matrix of m rows and n columns. The average brightness was calculated in each area as B_{i,j}. Along each row, the brightness difference between each area and the next adjacent area was calculated as ΔB_{i,j}=(B_{i,j-1}−B_{i,j}), for j=2 to n. The average of the brightness differences was calculated for each row as

$$Average Δ {B}_{i} = \frac{1}{n - 1} \sum ( {B}_{i , j - 1} - {B}_{i , j} )$$

for j=2 to n and the average of the brightness difference averages was calculated as:

$$Total row average BD = \frac{1}{m} \sum Average Δ {B}_{i}$$

for i=1 to m.

The Total column average BD is calculated similarly by determining brightness difference between adjacent areas along a column, the average brightness difference for each column, and the Total column average BD. The Total row average BD and the Total column average BD are summed to yield the Mura Index (MI). The Mura Score, which is related to the visual perception of warp, is calculated based on the MI as follows:

Mura score=((MI−10.61)/(29.42−10.61))×9+1.

TABLE 1

| Sample | | Top | | Bottom | | | | Visual | Average |
|---|---|---|---|---|---|---|---|---|---|
| Type | Matte | Film | T1 | Film | T2 | Tg | | Warp | Mura |
| No. | surface | Type | (microns) | Type | (microns) | (est.) | COF | Score | score |
| 1A | MICRO | TBEF3 | 44 | TBEF3 | 44 | 70 | 0.671 | Moderate | 1.3 |
| 2A | MICRO | TBEF3 | 44 | TBEF3 | 44 | 70 | 0.625 | Moderate | 1.2 |
| 3A | MICRO | TBEF3 | 44 | TBEF3 | 44 | 70 | 0.588 | Moderate | 1.1 |
| 4A | MICRO | TBEF3 | 44 | TBEF3 | 44 | 70 | 0.588 | Moderate | |
| 5A | NONE | BEFRP3 | 65 | TBEF3 | 44 | N/A | 1.676 | Severe | |
| 6A | NONE | BEFRP3 | 65 | TBEF3 | 44 | N/A | 1.676 | Severe | |
| 7A | NONE | BEFRP3 | 65 | TBEF3 | 44 | N/A | 1.676 | Severe | |
| 8A | NONE | BEFRP3 | 65 | TBEF3 | 44 | N/A | 1.676 | Severe | 2.8 |
| 9A | NONE | TBEF2 | 65 | TBEF3 | 44 | N/A | 0.851 | Moderate | |
| 10A | MICRO | BEFRP3 | 68 | TBEF3 | 44 | 55 | 0.700 | Moderate | |
| 11A | MICRO | BEFRP3 | 68 | TBEF3 | 44 | 55 | 0.700 | Moderate | |
| 12A | MICRO | BEFRP3 | 68 | TBEF3 | 44 | 55 | 0.700 | Moderate | |
| 13A | MICRO | BEFRP3 | 68 | TBEF3 | 44 | 55 | 0.700 | Moderate | |
| 14A | MICRO | BEFRP3 | 68 | TBEF3 | 44 | 55 | 0.700 | Moderate | |
| 15A | MICRO | BEFRP3 | 68 | TBEF3 | 44 | 55 | 0.700 | Moderate | |
| 16A | MICRO | BEFRP3 | 68 | TBEF3 | 44 | 55 | 0.700 | Moderate | |
| 17A | MICRO | BEFRP3 | 68 | TBEF3 | 44 | 55 | 0.700 | Moderate | |
| 18A | MICRO | BEFRP3 | 68 | TBEF3 | 44 | 55 | 0.700 | Moderate | |
| 19A | MICRO | BEFRP3 | 68 | TBEF3 | 44 | 55 | 0.700 | Moderate | |
| 20A | BEAD | TBEF2 | 65 | TBEF3 | 44 | 60 | 0.506 | Minimal | |
| 21A | BEAD | TBEF2 | 65 | TBEF2 | 44 | 60 | 0.588 | Minimal | |
| 22A | BEAD | TBEF2 | 65 | TBEF2 | 44 | 60 | 0.524 | Minimal | |
| 23A | BEAD | TBEF2 | 65 | TBEF2 | 44 | 60 | 0.506 | Minimal | |
| 24A | BEAD | TBEF2 | 65 | TBEF | 44 | 60 | 0.506 | Minimal | |
| 25A | MICRO | TBEF2 | 65 | TBEF2 | 44 | 70 | 0.620 | Minimal | |
| 26A | MICRO | BEFRP | 68 | BEFRP3 | 65 | 55 | 0.700 | Minimal | |
| 27A | MICRO | BEFRP | 68 | BEFRP3 | 65 | 55 | 0.700 | Minimal | |
| 28A | MICRO | BEFRP | 68 | BEFRP3 | 65 | 70 | 0.673 | Minimal | 1.9 |
| 29A | MICRO | BEFRP | 68 | BEFRP3 | 65 | 70 | 0.682 | Minimal | 2.2 |
| 30A | NONE | BEFRP2 | 115 | TBEF3 | 44 | N/A | 0.925 | Severe | |
| 31A | NONE | BEFRP2 | 115 | TBEF3 | 44 | N/A | 1.658 | Severe | |
| 32A | NONE | BEFRP3 | 65 | TBEF3 | 44 | N/A | 1.067 | Severe | |

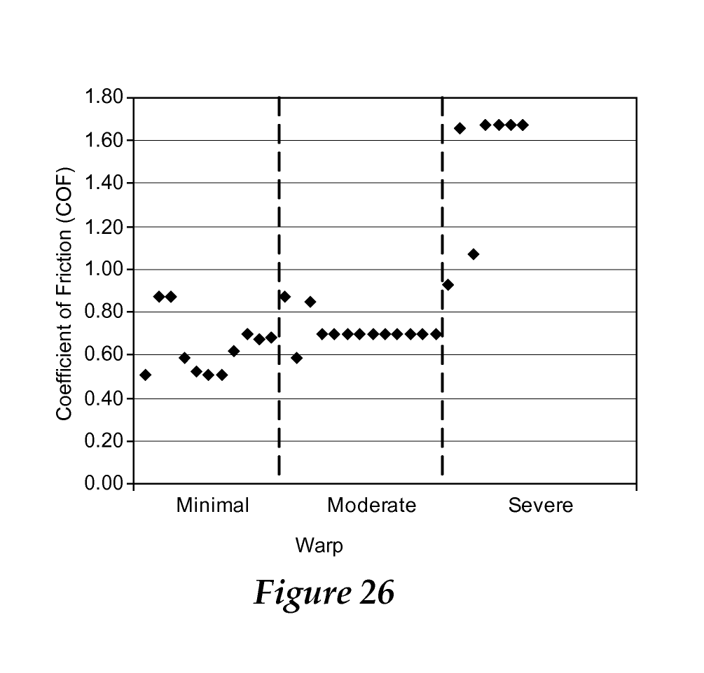

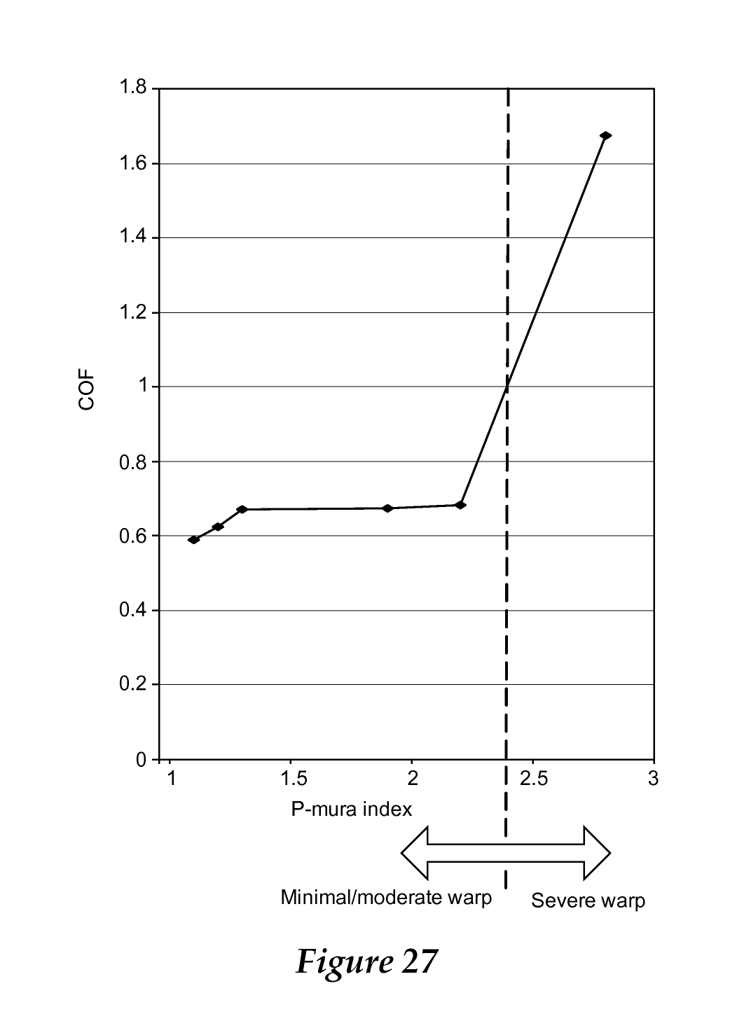

FIG. 26 illustrates the relationship between COF and the visual warp score for the sample types of Table 1. Sample types exhibiting minimal visual warp had an average COF of 0.589. Sample types exhibiting moderate visual warp had an average COF of 0.689. Sample types exhibiting severe warp had an average COF of 1.479. FIG. 27 illustrates the relationship between COF and Average Mura score for the samples of Table 1. For these samples, severe warp was associated with a Mura score greater than 2.5 or greater than 2.2.

Tables 2 and 3 provide test results for samples for which a Mura score was determined following environmental testing at 65° C./95% relative humidity for 72 hours. The optical film stack samples 1B-20B listed in Table 2 used various types of top and bottom films with a microreplicated matte surface having two types of microreplication pattern. Samples 1B-5B were fabricated with matte pattern 1, samples 6B-10B were fabricated with matte pattern 3. Samples 1B-10B used 17 pitch linear prisms on the top surface of the top film (BEFRP3). Samples 11B-15B are a first set of control samples using 17 micron pitch linear prisms on the top surface of the top film (BEFRP3). Samples 15B-20B are a second set of control samples using 24 micron pitch linear prisms on the top surface of the top film (BEFRP3).

TABLE 2

| | | Top | | Bottom | | | | | Average |
|---|---|---|---|---|---|---|---|---|---|
| Sample | Matte | Film | T1 | Film | T2 | Tg | | Mura | Mura |
| No. | layer | Type | (microns) | Type | (microns) | (est.) | Pattern | score | score |
| 1B | MICRO | BEFRP3 | 69 | TBEF3 | 57 | 70 | 1 | 1.7 | 1.9 |
| 2B | MICRO | BEFRP3 | 69 | TBEF3 | 57 | 70 | 1 | 2.0 | |
| 3B | MICRO | BEFRP3 | 69 | TBEF3 | 57 | 70 | 1 | 1.8 | |
| 4B | MICRO | BEFRP3 | 69 | TBEF3 | 57 | 70 | 1 | 1.9 | |
| 5B | MICRO | BEFRP3 | 69 | TBEF3 | 57 | 70 | 1 | 2.1 | |
| 6B | MICRO | BEFRP3 | 69 | TBEF3 | 57 | 70 | 3 | 2.1 | 2.2 |
| 7B | MICRO | BEFRP3 | 69 | TBEF3 | 57 | 70 | 3 | 2.1 | |
| 8B | MICRO | BEFRP3 | 69 | TBEF3 | 57 | 70 | 3 | 2.2 | |
| 9B | MICRO | BEFRP3 | 69 | TBEF3 | 57 | 70 | 3 | 2.3 | |
| 10B | MICRO | BEFRP3 | 69 | TBEF3 | 57 | 70 | 3 | 2.1 | |
| 11B | NONE | BEFRP3 | 69 | TBEF3 | 57 | N/A | N/A | 2.3 | 2.8 |
| 12B | NONE | BEFRP3 | 69 | TBEF3 | 57 | N/A | N/A | 1.8 | |
| 13B | NONE | BEFRP3 | 69 | TBEF3 | 57 | N/A | N/A | 2.3 | |
| 14B | NONE | BEFRP3 | 69 | TBEF3 | 57 | N/A | N/A | 3.3 | |
| 15B | NONE | BEFRP3 | 69 | TBEF3 | 57 | N/A | N/A | 4.3 | |
| 16B | NONE | BEFRP3 | 69 | TBEF3 | 57 | N/A | N/A | 3.4 | 2.6 |
| 17B | NONE | BEFRP3 | 69 | TBEF3 | 57 | N/A | N/A | 2.0 | |
| 18B | NONE | BEFRP3 | 69 | TBEF3 | 57 | N/A | N/A | 3.4 | |
| 19B | NONE | BEFRP3 | 69 | TBEF3 | 57 | N/A | N/A | 2.0 | |
| 20B | NONE | BEFRP3 | 69 | TBEF3 | 57 | N/A | N/A | 2.3 | |

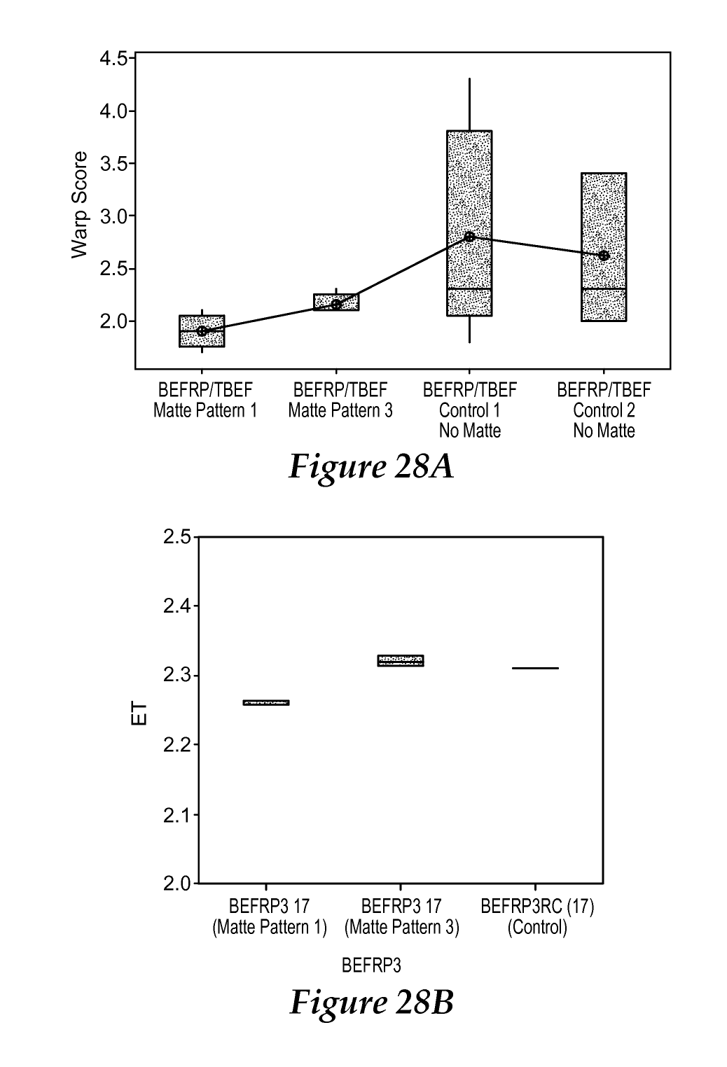

FIG. 28A is a statistical plot of the Mura score for test groups 1B-5B and 6B-10B, and control groups 11B-15B and 16B-20B listed in Table 2. As can be appreciated from FIG. 28A, the test samples having the matte surface show improved (lower) warp scores and smaller warp variability when compared to the warp scores of the control samples. FIG. 28B shows ETA for the test groups 1B-5B and 6B-10B, and control groups 11B-15B and 16B-20B listed in Table 2. As illustrated by FIG. 28B, the addition of a matte surface does not substantially decrease ETA, or decreases ETA only minimally.

The optical film stack samples 1C-20C listed in Table 3 used various types of top and bottom films with a microreplicated matte surface having a low haze, medium haze, and high haze microreplication patterns. Samples 1C-5C were fabricated with a low haze matte pattern, samples 6C-10C were fabricated with a medium haze matte pattern, and samples 11C-15C were fabricated with a high haze matte pattern. Samples 16C-20C were control samples All bottom films and the top films in the control samples used 24 pitch linear prisms on the top surface of the films (TBEF3).

TABLE 3

| | | Top | | Bottom | | | | | Average |
|---|---|---|---|---|---|---|---|---|---|
| Sample | Matte | Film | T1 | Film | T2 | Tg | | Mura | Mura |
| No. | layer | Type | (microns) | Type | (microns) | (est.) | Pattern | score | score |
| 1C | MICRO | TBEF3 | 44 | TBEF3 | 44 | 70 | Low Haze | 1.6 | 1.3 |
| 2C | MICRO | TBEF3 | 44 | TBEF3 | 44 | 70 | Low Haze | 1.3 | |
| 3C | MICRO | TBEF3 | 44 | TBEF3 | 44 | 70 | Low Haze | 1.2 | |
| 4C | MICRO | TBEF3 | 44 | TBEF3 | 44 | 70 | Low Haze | 1.4 | |
| 5C | MICRO | TBEF3 | 44 | TBEF3 | 44 | 70 | Low Haze | 1.1 | |
| 6C | MICRO | TBEF3 | 44 | TBEF3 | 44 | 70 | Mid Haze | 1.0 | 1.2 |
| 7C | MICRO | TBEF3 | 44 | TBEF3 | 44 | 70 | Mid Haze | 1.5 | |
| 8C | MICRO | TBEF3 | 44 | TBEF3 | 44 | 70 | Mid Haze | 0.9 | |
| 9C | MICRO | TBEF3 | 44 | TBEF3 | 44 | 70 | Mid Haze | 1.6 | |
| 10C | MICRO | TBEF3 | 44 | TBEF3 | 44 | 70 | Mid Haze | 1.0 | |
| 11C | MICRO | TBEF3 | 44 | TBEF3 | 44 | N/A | High Haze | 1.3 | 1.1 |
| 12C | MICRO | TBEF3 | 44 | TBEF3 | 44 | N/A | High Haze | 0.8 | |
| 13C | MICRO | TBEF3 | 44 | TBEF3 | 44 | N/A | High Haze | 1.0 | |
| 14C | MICRO | TBEF3 | 44 | TBEF3 | 44 | N/A | High Haze | 1.1 | |
| 15C | MICRO | TBEF3 | 44 | TBEF3 | 44 | N/A | High Haze | 1.4 | |
| 16C | NONE | TBEF3 | 44 | TBEF3 | 44 | N/A | N/A | 3.7 | 3.6 |
| 17C | NONE | TBEF3 | 44 | TBEF3 | 44 | N/A | N/A | 3.6 | |
| 18C | NONE | TBEF3 | 44 | TBEF3 | 44 | N/A | N/A | 4.1 | |
| 19C | NONE | TBEF3 | 44 | TBEF3 | 44 | N/A | N/A | 4.1 | |
| 20C | NONE | TBEF3 | 44 | TBEF3 | 44 | N/A | N/A | 2.6 | |

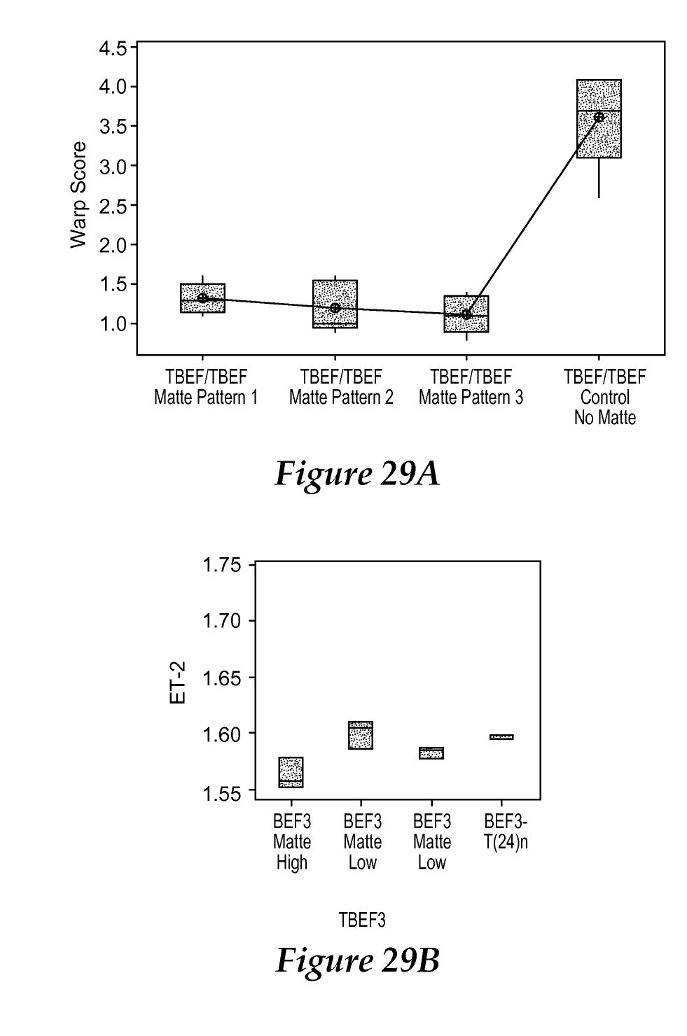

FIG. 29A is a statistical plot of the Mura score for test groups 1C-5C,6C-10C, 11C-15C, and control group 16C-20C listed in Table 3. As can be appreciated from FIG. 28B, the test samples having the matte surface show improved (lower) warp scores over the warp scores and lower warp variability when compared to the control samples.

FIG. 29B shows ETA for the test groups 1C-5C and 6C-10C, 11C-15C and control groups 16C-20C and listed in Table 3. As illustrated by FIG. 29B, the addition of a matte surface on TBEF does not substantially decrease ETA, or decreases ETA only minimally.

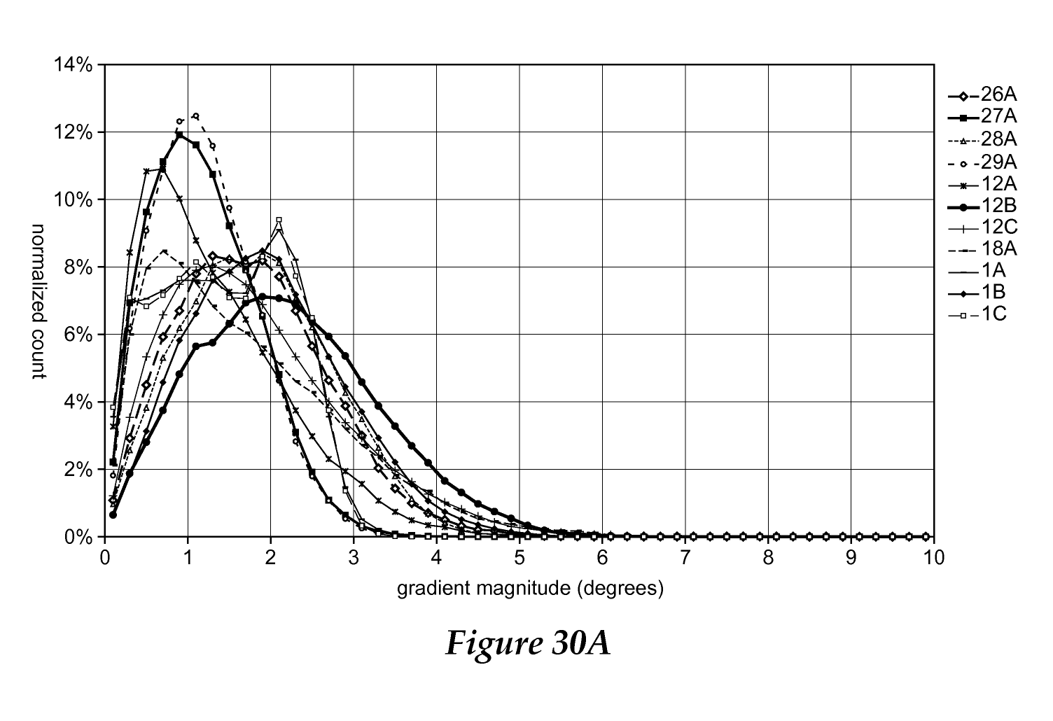

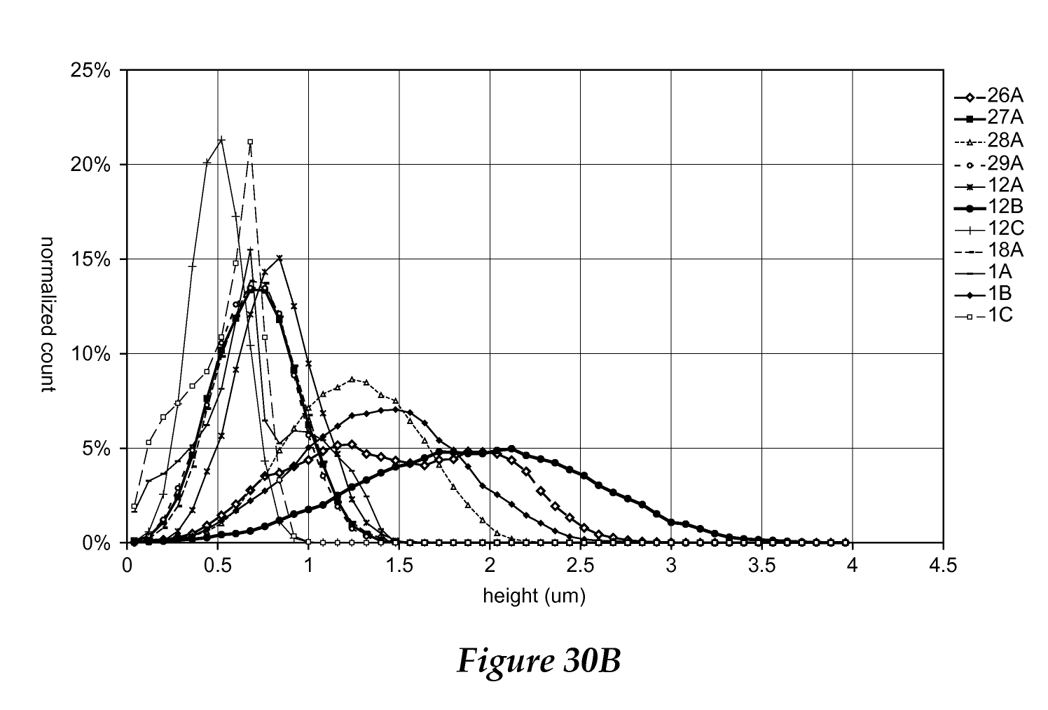

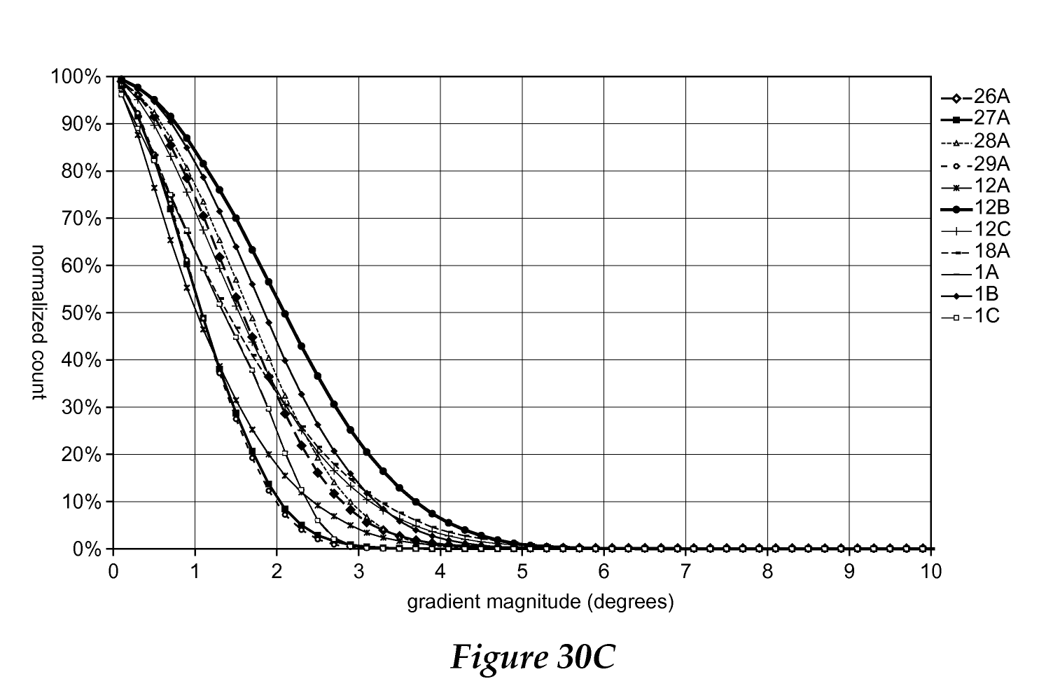

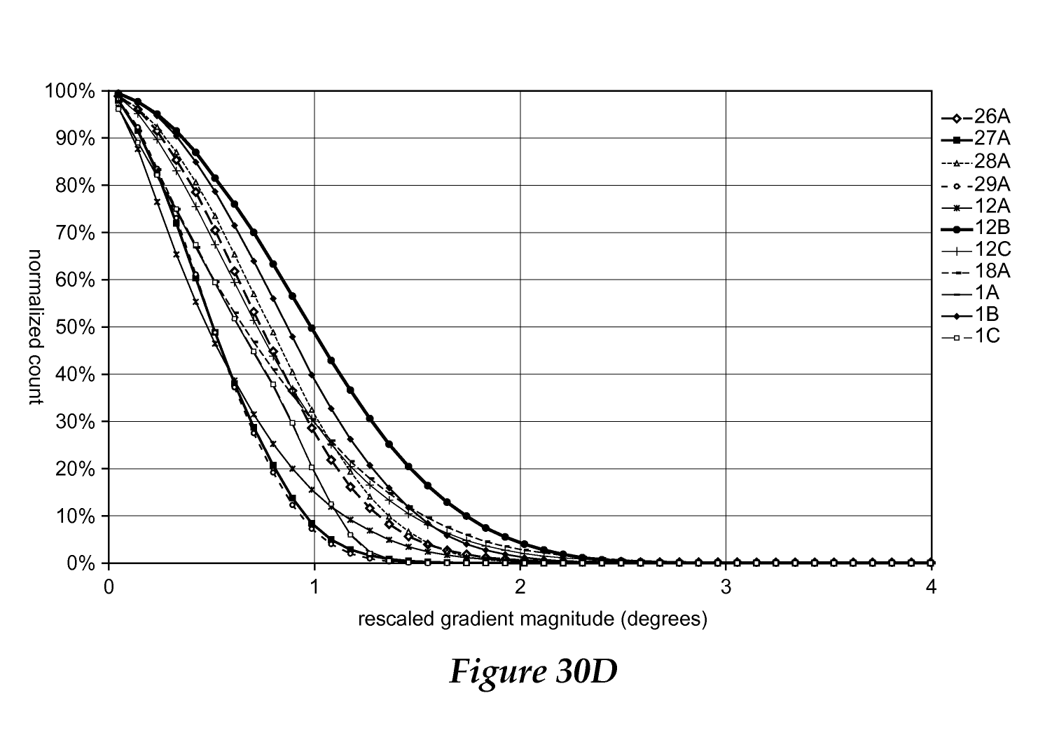

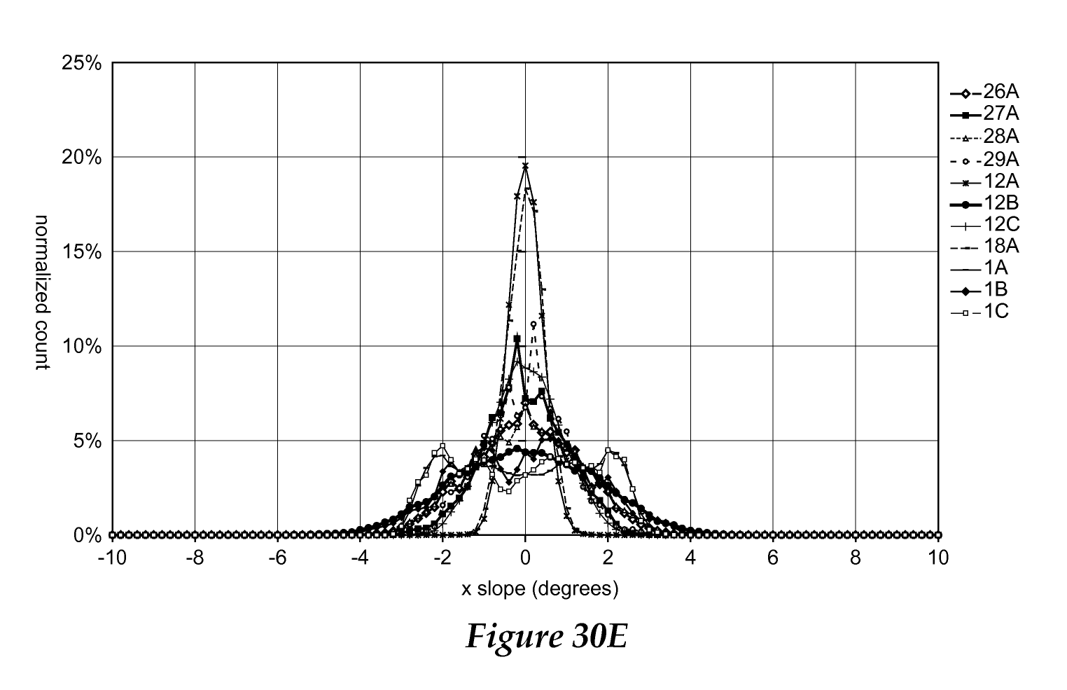

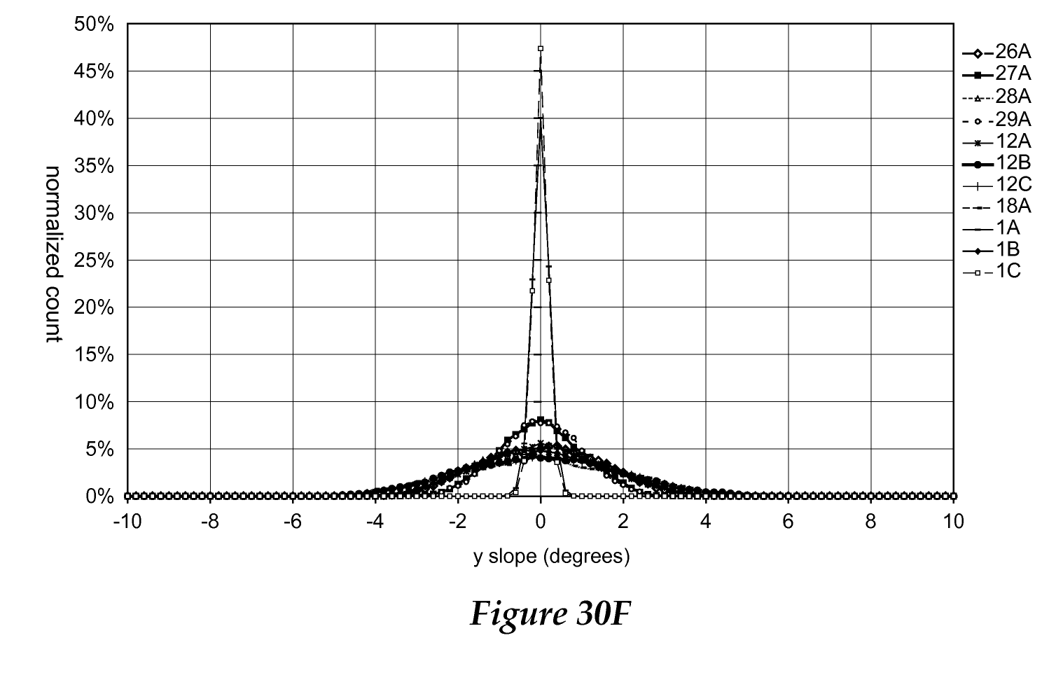

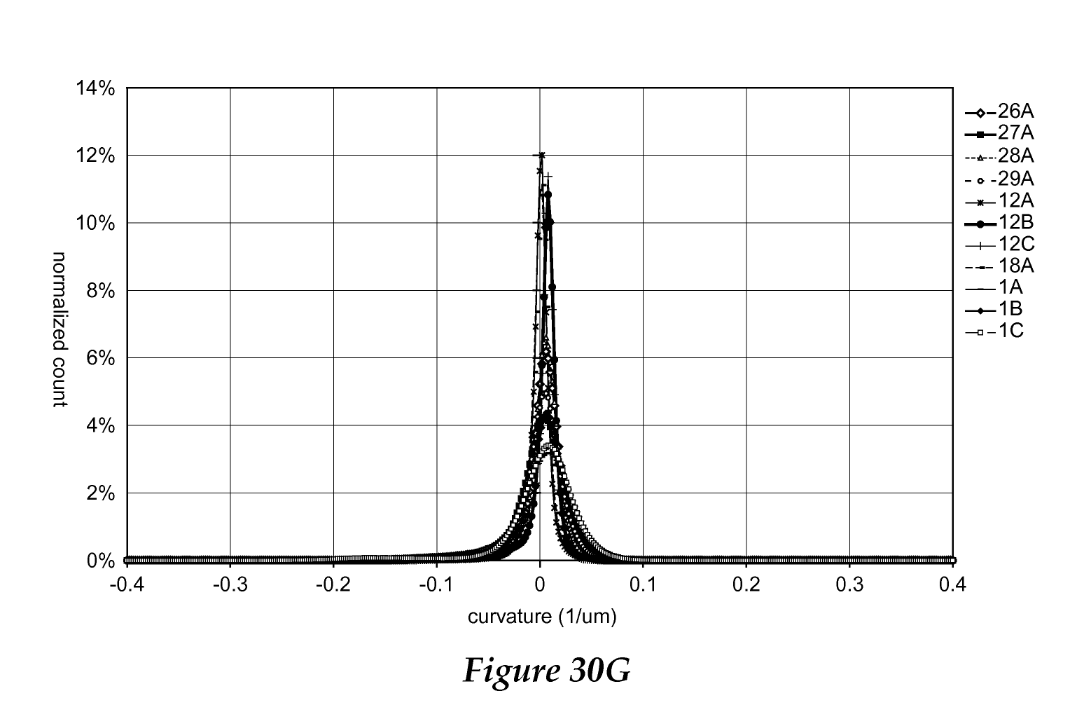

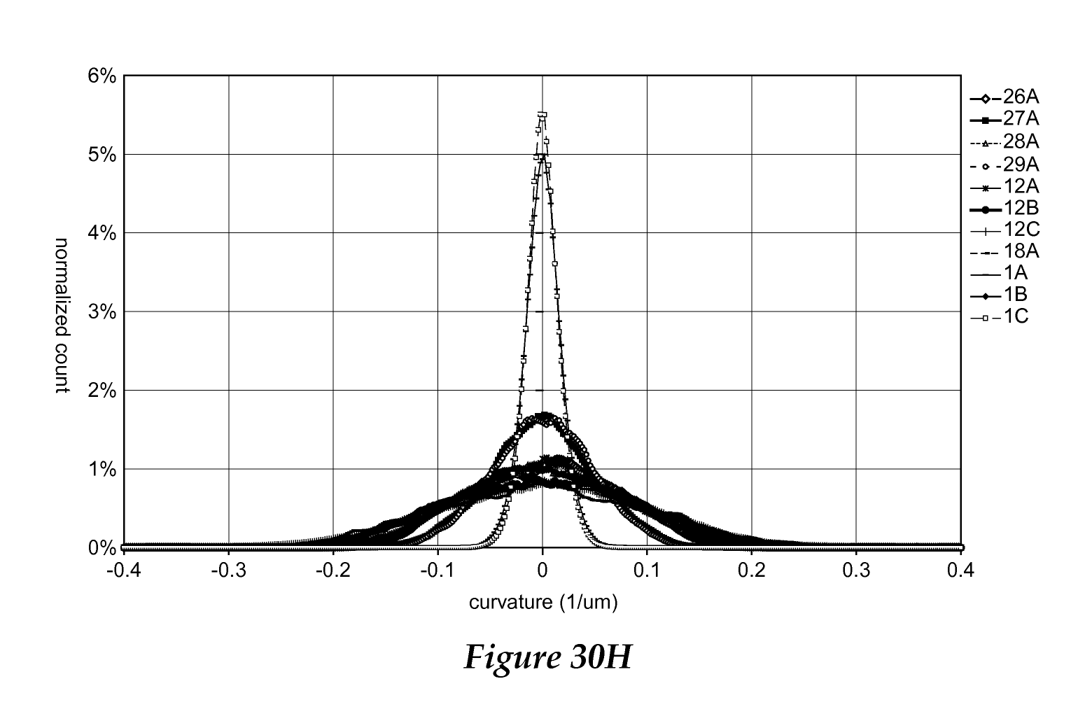

Surface characterization was performed using confocal scanning laser microscopy to obtain surface profiles for various matte surfaces formed by microreplication. The sample types tested corresponded to sample types 1A, 1B, 1C, 12A, 12B, 12C, 18A, 26A (two samples) 27A, 27B The matte surfaces tested had an estimated Tg in a range of about 55 to 75° C., thickness between 44 microns to 70 microns. The microreplicated surface geometries illustrated in Table 4 and FIGS. 30A-30H are comparable to microreplicated surface geometries of films having a measured COF less than 1 and yielding improved warp performance as described above. FIGS. 30A-30H graphically illustrate the following surface characterizations: FIG. 30A—gradient magnitude distribution, FIG. 30B—height distributions; FIG. 30C—complement of the cumulative gradient magnitude distribution (Fcc); FIG. 30D—complement of the cumulative gradient magnitude distribution—rescaled (Rcc); FIG. 30E—X slope distribution; FIG. 30F—y slope distribution; FIG. 30G—X-curvature distribution; FIG. 30H—Y curvature distribution.

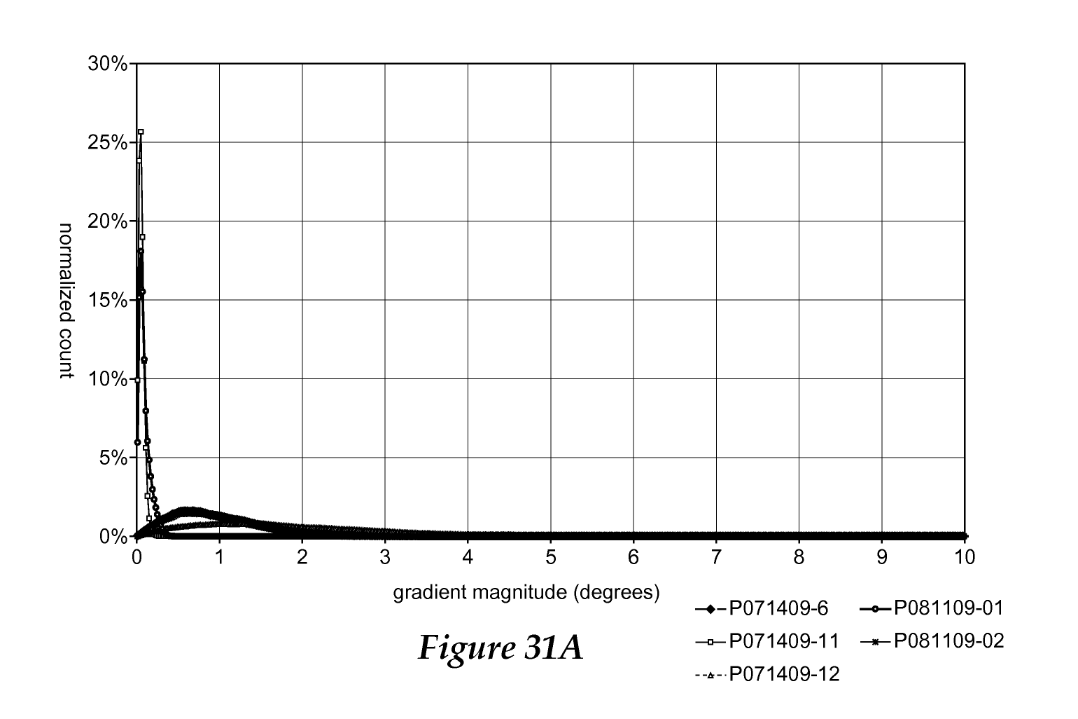

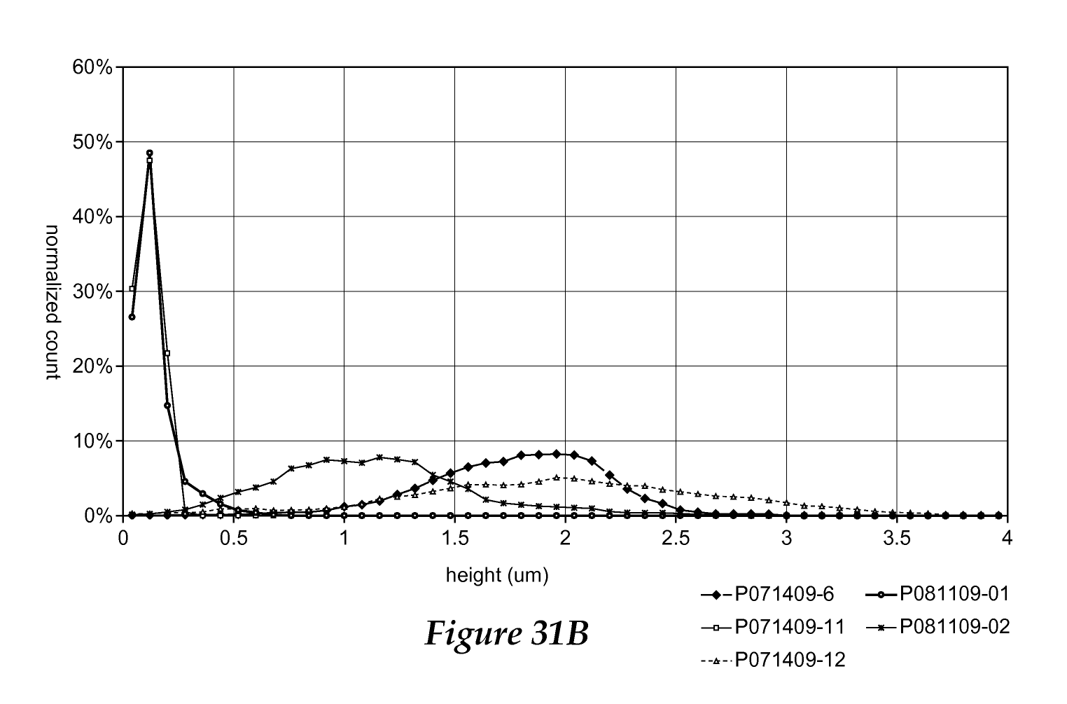

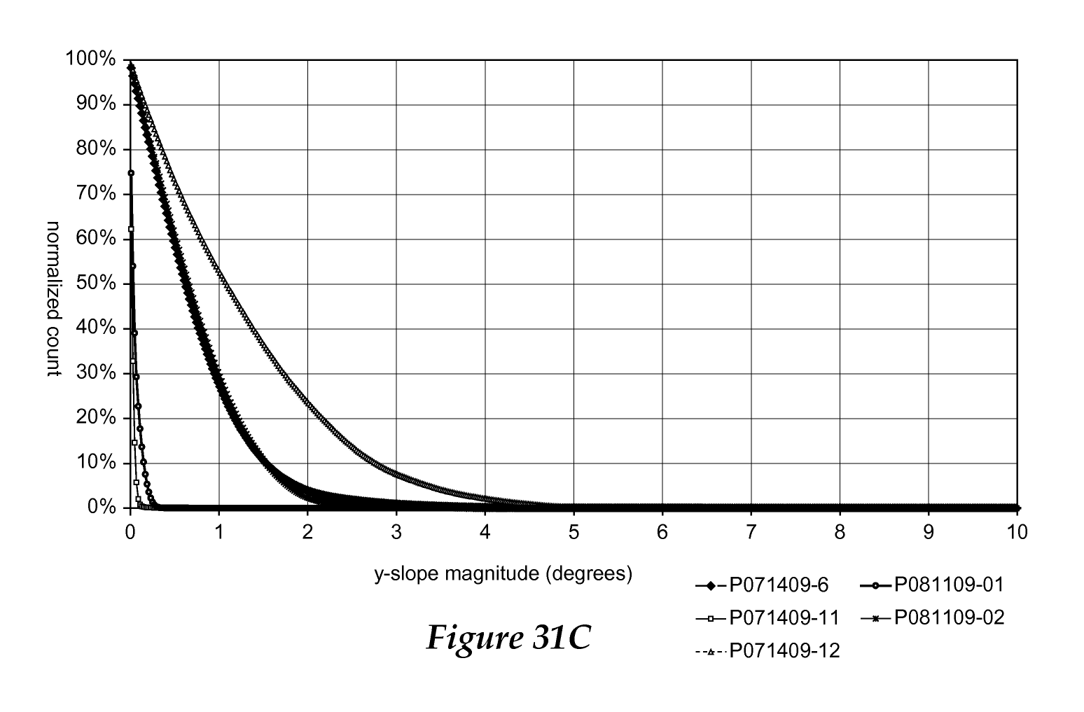

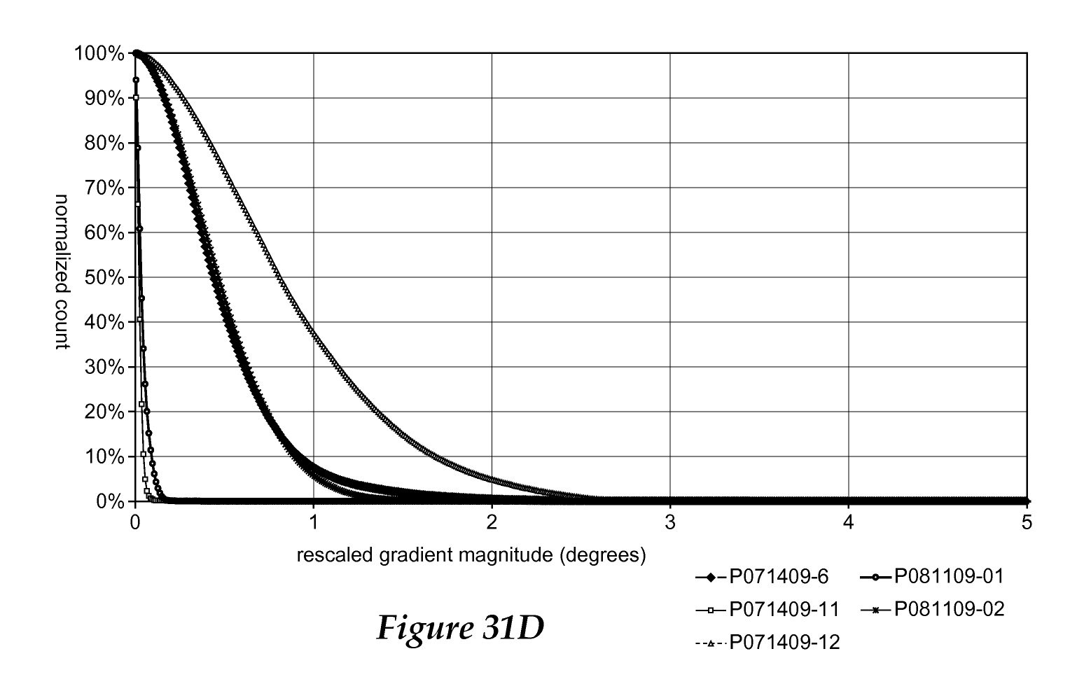

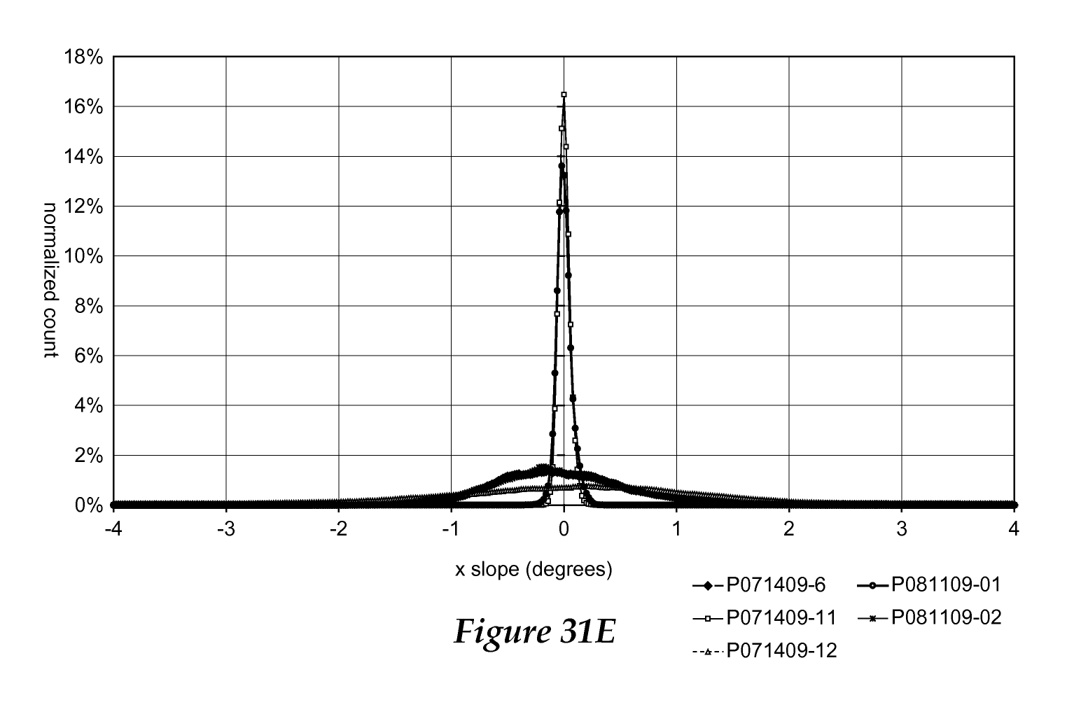

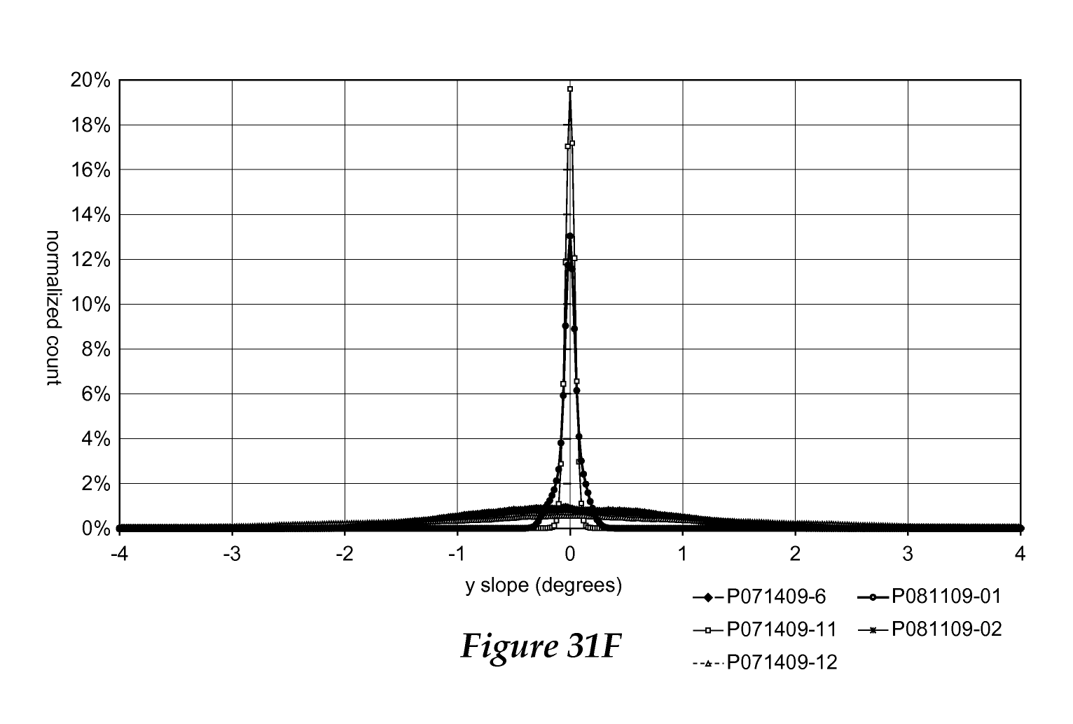

The face-side roller process previously described can also be used to produce films surface geometries comparable to the microreplicated patterns described above. FIGS. 31A-31H summarize the surface characterization of typical films produced by the face-side roll process. FIGS. 31A-31F graphically illustrate the following surface characterizations: FIG. 31A—gradient magnitude distribution, FIG. 31B—height distributions; FIG. 31C—complement of the cumulative gradient magnitude distribution (Fcc); FIG. 31D—complement of the cumulative gradient magnitude distribution—rescaled (Rcc); FIG. 31E—X slope distribution; FIG. 31F—y slope distribution.

The process may be used to produce films having an optical haze that is not greater than about 5%, or not greater than about 4.5%, or not greater than about 4%, or not greater than about 3.5%, or not greater than about 3%, or not greater than about 2.5%, or not greater than about 2%, or not greater than about 1.5%, or not greater than about 1%; and an optical clarity that is not greater than about 85%, or not greater than about 80%, or not greater than about 75%, or not greater than about 70%, or not greater than about 65%, or not greater than about 60%. Furthermore, the addition of the matte surface using the face-side process does not substantially decrease, or only minimally decreases the ETA, e.g., a decrease in ETA of less than about 2% or less than about 3% or less than about 5%, when compared to an identical optical film without the matte surface formed using the face-side roll process.

The COF of matte formed using the face-side roll process is dependent on the surface active chemicals added to the resin used to coat the substrate and form the matte surface. Table 4 presents COF data and the for films with and without matte surfaces and with and without surface chemistry additives.

TABLE 4

| | | Surface | | | | | |
|---|---|---|---|---|---|---|---|
| | | Active | | | est. Tg | | Thickness |
| Sample ID | Matte | Chemistry | Resin | Solution | (C.) | COF | (micron) |
| P071409- | yes | HFPO- | SR444 and SR344 | Axon HC + | 86 | 0.681 | 2 |
| 06 | | PEG | with SiNaps | 0.075% HFPO- | | | |
| | | | nanoparticles | PEG 20% Solids | | | |
| P070709- | yes | HFPO-UA | SR444 and SR344 | Axon HC + | 86 | 0.828 | 2 |
| 14 | | | with SiNaps | 0.075% HFPO- | | | |
| | | | nanoparticles | UA | | | |
| P102407- | yes | none | SR9041 | 100% SR9041 | 102 | 0.605 | 2 |
| 20 | | | | (Lot JMF1128) + | | | |
| | | | | Darocur 1173 | | | |
| P102507- | yes | none | CN9008 | 100% CN9008 | 111 | 0.605 | 2 |
| 37 | | | | (Lot VKH0767) + | | | |
| | | | | Darocur 1173 | | | |
| P012909- | yes | none | Photomer 6010 and | P6010/SR355 | 27 | 0.923 | 2 |
| 31 | | | SR355 | (60:40) | | | |
| | | | | 2% Darocur | | | |
| | | | | 4265 | | | |
| P102607- | yes | none | 906HC (funct. 20 nm | 906HC w/20% | 87 | 0.560 | 2 |
| 79 | | | SiO2 particles and | on solids | | | |
| | | | SR444 & dimethyl | SR9003 | | | |
| | | | acrylamide resins) | | | | |
| | | | and SR9003 resin | | | | |
| P012909- | yes | none | Photomer 6010 and | P6010/SR355 | 27 | 0.923 | 2 |
| 31 | | | SR355 | (60:40) | | | |
| | | | | 2% Darocur | | | |
| | | | | 4265 | | | |
| P012909- | yes | Tegorad | Photomer 6010 and | P012909-S2 | 27 | 0.570 | 2 |
| 34 | | 2250 | SR355 | (P6010/SR355 + | | | |
| | | Silicone | | 0.05% Tegorad | | | |
| | | | | wt/solution) | | | |
| P012909- | yes | Tegorad | Photomer 6010 and | P012909-S3 | 27 | 0.489 | 2 |
| 37 | | 2250 | SR355 | (P6010/SR355 + | | | |
| | | Silicone | | 0.1% Tegorad | | | |
| | | | | wt/solution) | | | |
| P012909- | yes | Tegorad | Photomer 6010 and | P012909-S4 | 27 | 0.268 | 2 |
| 40 | | 2250 | SR355 | (P6010/SR355 + | | | |
| | | Silicone | | 0.2% Tegorad | | | |
| | | | | wt/solution) | | | |

Axon HC formulation is provided in Table 5:

TABLE 5

| Material | Solids (%) | Formulation (g) | Wt % of Solution (%) |
|---|---|---|---|
| SiNaps | 43 | 894.5 | 21.2 |
| Irgacur 184 | 100 | 27.3 | 0.6 |
| SR444 | 100% | 575.9 | 13.7 |
| SR344 | 100% | 90.3 | 2.1 |
| IPA | 0 | 1517.2 | 36.0 |
| EtAc | 0% | 1112.5 | 26.4 |
| TOTAL | | 4217.7 | 100 |
| Solids | | 25.65 | |
| W % Silica | | | |
| on Solids | | 35.89 | |

A vessel was charged with 575.9 g of pentaerythritol tri- and tetra-acrylate (such as SR444 available from Sartomer), 90.3 g of polyethyleneglycol diacrylate (such as SR344 available from Sartomer) and 500 g isopropanol. Then 894.5 g of A-174 modified silica organosol in 1-methoxy-2-propanol was added, rinsing with 563.8 g of isopropanol. In a separate container, 27.3 g of 1-hydroxy-cyclohexyl phenyl ketone (such as Irgacure 184 available from Ciba) was mixed with 180 g of ethyl acetate. This pre-mix solution was added to the mixture above, rinsing with 600 g of ethyl acetate. The mixture was mixed thoroughly to obtain a uniform mixture.

The above mixture was further diluted with isopropanol and ethyl acetate prior to coating.

3-methacryloxypropyltrimethoxysilane was available as Silquest A174 from Momentive performance materials, Inc., Friendly, W. Va. Irgacure 184, photoinitiator, 1-hydroxy-cyclohexy-pheny-ketone was obtained from Ciba Special Chemicals, Tarrytown, N.Y. Pentaerythritol acrylate (SR444) and Polyethylene Glycol (400) Diacrylate (SR344) were obtained from Sartomer Company, Exton, Pa. Solvents (MEK, Toluene, IPA, Ethyl Acetate] all from Brenntag, Brenntag Great Lakes, P.O. Box 444, Butler, Wis. 53007, Coated on Dupont Melinex® 618—a super clear polyester film, pretreated on one side to promote adhesion. A very unique film with ultra high clarity for a wide range of Display applications. The SiNaps are prepared using Nalco 2327 aqueous colloidal silica, A-174 and 1-methoxy-2-propanol (such as Dowanol PM). HFPO-PEG is described in commonly owned U.S. patent application identified by Docket Number 63834US002, filed Jan. 16, 2008 which is incorporated herein by reference.

SiNapps was made using the following process: A 12 liter flask was charged with 3000 g of aqueous colloidal silica solution (such as Nalco 2327 available from Nalco, Napierville, Ill.) and stirring was started. Then 3591 g of 1-Methoxy-2-propanol (such as Dowanol PM available from Dow Chemical, Midland, Mich.) was added. In a separate container, 189.1 g of 3-methacryloxypropyltrimethoxy silane (such as Silquest A-174 available from Momentive Performance Materials, Wilton, Conn.) was mixed with 455 g of 1-methoxy-2-propanol. This pre-mix solution was added to the flask, rinsing with 455 g of 1-methoxy-2-propanol. The mixture was heated to 80° C. for about 16 hours. The mixture was cooled to 35° C. The mixture was set up for vacuum distillation (30-35 Torr, 35-40° C.) with a collection flask. An additional 1813.5 g of 1-methoxy-2-propanol was added to the reaction flask part way through the distillation. A total of 6784 g of distillate was collected. The mixture was tested for % solids by drying a small sample in a tared aluminum pan for 60 minutes in a 105° C. oven. The mixture was found to be 52.8% solids. An additional 250 g of 1-methoxy-2-propanol was added and the mixture was stirred. The % solids was tested and found to be 48.2%. The mixture was collected by filtering through cheesecloth to remove particulate debris. A total of 2841 g of product solution was obtained.

The HFPO urethane acrylate used was made by a procedure similar to that in Preparation 6 of US Patent Publication 2006/0216524 which is incorporated herein by reference, substituting 0.10 mole fraction of the HFPO amidol (HFPOC(O)NHCH2CH2OH) for the 0.15 mole fraction HFPO amidol used in Preparation 6, substituting 0.95 mole fraction of the pentaerythritol triacrylate for the 0.90 mole fraction pentaerythritol triacrylate used in Preparation 6, adding the HFPO amidol (HFPOC(O)NHCH2CH2OH) to the Desmodur N100 over a period of about one hour, and running the reaction at 30% solids in methyl ethyl ketone, instead of at 50% solids in methyl ethyl ketone.

Additional information regarding the samples of TABLE 4 and other samples is provided in Table 6.

TABLE 6

| | | | | | | Surface | |
|---|---|---|---|---|---|---|---|
| | | Sample | | | | Active | |
| Comparison | Comments | ID | Tg | COF | Resin | Chemistry | Solution |
| matte w/ | reduces | P017409- | 86 | 0.681 | SR444 and | HFPO- | Axon HC + |
| surface | friction. | 06 | | | SR244 with | PEG | 0.075% |
| active | Addition | | | | SiNaps | | HFPO-PEG |
| chemistry | of HFPO- | | | | nanoparticles | | 20% solids |
| | PEG | | | | | | |
| | reduces | | | | | | |
| | friction | | | | | | |
| same amount | increased | P070709- | 86 | 0.828 | SR444 and | HFPO | Axon HC + |
| of surfactant | COF | 14 | | | SR344 with | Urethane | 0.075% |
| but different | | | | | SiNaps | Acrylate | HFPO-UA |
| chemistry | | | | | nanoparticles | | |
| has a higher | | | | | | | |
| COF | | | | | | | |
| High Tg | Tested for | P102407- | 102 | 0.605 | SR9041 | none | 100% SR9041 |
| Resin | wetout | 20 | | | | | (Lot |
| | | | | | | | JMF1128) + |
| | | | | | | | Darocur173 |
| High TG | | P102507- | 111 | 0.605 | CN9008 | none | 100% |
| resin | | 37 | | | | | CN9008 (Lot |
| | | | | | | | VKH0767) + |
| | | | | | | | Darocur 1173 |
| Low TG | reference | P012909- | 27 | 0.923 | Photomer | none | P6010/SR355 |
| resin | TG based | 31 | | | 6010 and | | (60:40)2% |
| | on | | | | SR355 | | Darocur 4265 |
| | weighted | | | | | | |
| | sum of Tg | | | | | | |
| | of 6010 | | | | | | |
| | (−7 C.) and | | | | | | |
| | Tg of 355 | | | | | | |
| | (98 C.) | | | | | | |
| High Tg | Low Haze | P102607- | 104 | 0.560 | 906HC | none | 906HC |
| resin with | 606 blend | 79 | | | (funct. 20 | | w/20% on |
| nanoparticles | on TDO | | | | NM SiO2 | | solids SR9003 |
| | | | | | particles and | | |
| | | | | | SR444 and | | |
| | | | | | dimethyl | | |
| | | | | | acrylamide | | |
| | | | | | resins) and | | |
| | | | | | SR9003 | | |
| | | | | | resin | | |
| low Tg resin | SR355 | P012909- | 27 | 0.923 | Photomer | none | P6010/SR355 |
| no surface | was added | 31 | | | 6010 and | | (60:40) 2% |
| active | to 6010 to | | | | SR355 | | Darocur 4265 |
| chemistry | adjust | | | | | | |
| | viscosity | | | | | | |
| | and | | | | | | |
| | increase | | | | | | |
| | Tg | | | | | | |
| Adding | | P012909- | 27 | 0.569 | Photomer | Tegorad | P012909-S2 |
| surface | | 34 | | | 6010 and | 2250 | (P6010/SR355 + |
| active | | | | | SR355 | Silicone | 0.05% Tegorad |
| chemistry to | | | | | | | wt/solution) |
| low Tg resin | | | | | | | |
| reduces COF | | | | | | | |
| More surface | | P012909- | 27 | 0.489 | Photomer | Tegorad | P012909-S3 |
| active | | 27 | | | 6010 and | 2250 | (P6010/SR355 + |
| chemistry | | | | | SR355 | Silicone | 0.05% Tegorad |
| reduces COF | | | | | | | wt/solution) |
| More surface | | P012909- | 27 | 0.268 | Photomer | Tegorad | P012909-S4 |
| active | | 40 | | | 6010 and | 2250 | (P6010/SR355 + |
| chemistry | | | | | SR355 | Silicone | 0.05% Tegorad |
| reduces COF | | | | | | | wt/solution) |

Comparison of Samples P0811009-01 and P0811009-02 illustrates that, in the absence of surface chemistry additives, the addition of a matte surface lowers the COF. Samples P0811009-01 and P0811009-02 do not include surface active chemistry additives. Sample P0811009-02 has a matte surface, whereas P0811009-01 does not have a matte surface. The COF of P0811009-02 is lower than that of P0811009-01 due to the matte surface.

Surface chemistry additives to the resin used to coat the substrate also lower the COF even in the absence of a matte surface. When surface chemistry additives are used, the matte surface may not produce a lower COF than an identically processed film without a matte surface. This phenomenon arises because during the formation of non-matte (gloss) films, the surface chemistry has more time to diffuse to the surface and influence the COF compared to the formation of a matte surface. For example, sample P071409-11 has no matte surface and a COF (0.547) that is lower than the COF (0.586) of a comparable sample (P071409-12) that includes a matte surface. Decreasing the amount of surface active chemistry additive in a sample film (P071409-6) that has a matte surface further increases the COF (0.681)

Samples P070709-14 and -P071409-06 have the same amount of surfactant but the structured coating containing HFPO-UA has higher COF compared to the structured coating containing HFPO-PEG

Samples P102407-20, P102507-37, P012909-31, and P102607-79 show that we can also reduce the COF of a coating by using a resin with a higher Glass Transition Temperature. The 906 HC which contains 37% silica nanoparticles has a higher Tg than the SR444 resin alone (103) has a further reduced COF compared to the resins without nanoparticles. Sample P012909-31, P012909-34, P012909-37, and P012909-40 show that adding a surface active agent (Tegorad 2250) to a low Tg resin will also reduce the COF. Adding more of the surfactant reduces the COF further. Materials are listed below.

The 6010/355 resin blends were made at 20% solids in IPA with a 60:40 ratios of PHotomer 6010 to SR355. Darocure 4265 photoinitiator was added at 2% by weight of the solids to the solution. The SR9041 material was made in a solution at 30% solids in MEK. The CN9008 materials was made in a solution at 30% solids in MEK. The 906 HC and SR9003 material at a ratio of 80 to 20 was coated at 30% solids in IPA.

The HFPO urethane acrylate used was made by a procedure similar to that in Preparation 6 of US Patent Publication 2006/0216524 which is incorporated herein by reference The reference for the HFPO UA below is as follows:

41-4205-6329-2 R-56329 made at 30% solids in MEK has the formulation

DES N100/0.10 HFPOC(O)NHCH2CH2OH/0.95 PET3A

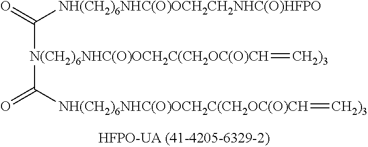

The HFPO urethane acrylate used was made by a procedure similar to that in Preparation 6 of US 20060216524, substituting 0.10 mole fraction of the HFPO amidol (HFPOC(O)NHCH2CH2OH) for the 0.15 mole fraction HFPO amidol used in Preparation 6, substituting 0.95 mole fraction of the pentaerythritol triacrylate for the 0.90 mole fraction pentaerythritol triacrylate used in Preparation 6, adding the HFPO amidol (HFPOC(O)NHCH2CH2OH) to the Desmodur N100 over a period of about one hour, and running the reaction at 30% solids in methyl ethyl ketone, instead of at 50% solids in methyl ethyl ketone.

Tegorad 2250 silicone polyether acrylate, radically cross-linkable from Tego Chemie Service GmbH•Goldschmidtstrasse 100•D-45127 Essen•Tel.: +49 (0)201/173-2222•Fax: +49 (0)201/173-1939 (www.tego.de).

According to U.S. Pat. No. 5,677,050 (column 10), which is incorporated by reference herein, the 906 HC was prepared as follows: The following materials were charged into a 10 liter round-bottled flask: 1195 grams (g) Nalco 2327, 118 g NNDMA, 60 g Z6030 and 761 g PETA. The flask was then placed on a Bucchi R152 rotary evaporator with the bath temperature set at 55° C. A refrigerated mixture of 50% deionized water/50% antifreeze recirculated through the cooling coils. Volatile components were removed at a reduced pressure of approximately 25 Torr until the distillation rate was reduced to less than 5 drops per minute (approximately 2 hour). The resulting material (1464 g) was a clear liquid, containing less than 1% water and comprising 54.2% PETA, 8.4% NNDMA, and 38.8% acrylate silica. SR9003, propoxylated neopentyl glycol diacrylate, CN9008, a trifunctional aliphatic polyesterurethane acrylate oligomer and SR-355, ditrimethylolpropane tetraacrylate are available from Sartomer Company, Inc., Exton Pa.

PHOTOMER 6010 is an aliphatic urethane acrylate oligomer available from Cognis www.cognis.com. SR9041-SR9041 [Pentaacrylate Ester] is available from Sartomer Company, Inc. 502 Thomas Jones Way. Exton, Pa. 19341.

Darocure 1173 [2-Hydroxy-2-methyl-1-phenyl-1-propanone] and Daracure 4265 [50 wt % Diphenyl (2,4,6-trimethylbenzoyl)-phosphine oxide, 50 wt % Darocur 1173] are available from Ciba Corporation, P.O. Box 2005, 540 White Plains Road, Tarrytown, N.Y. 10591-9005.

The optical film stacks described herein may be used as light management films for backlights used in display systems or laptop computers, the small displays found on cellphones and miniature music players, and other devices. In some applications, a light management optical film stack comprising a diffuser, an polarizer and one or more brightness enhancement films are arranged between a light source and an LCD matrix.

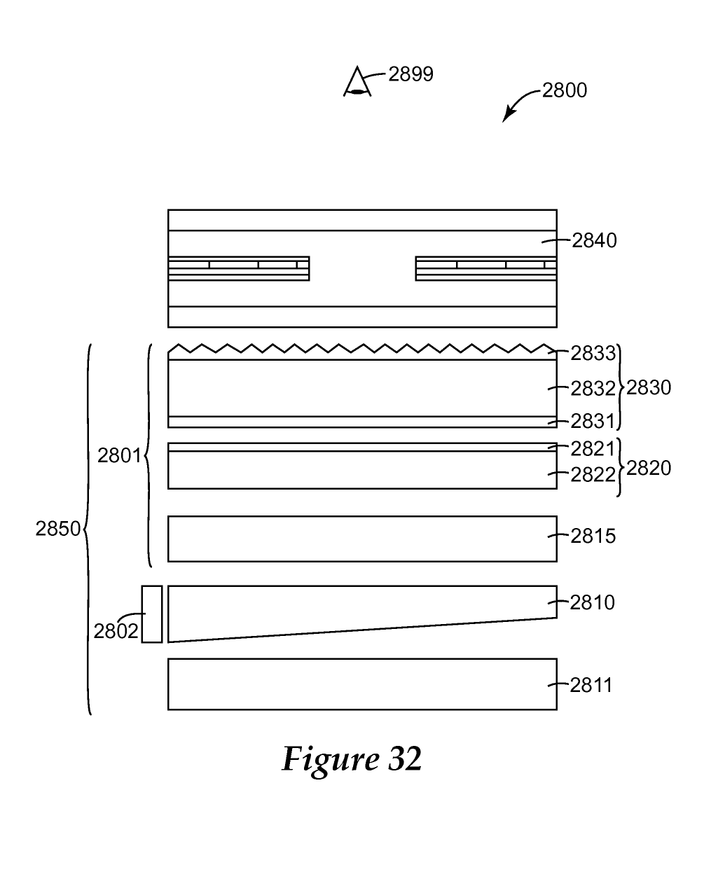

FIG. 32 is a schematic side-view of one example of a display system 2800 for displaying information to a viewer 2899. The display system 2800 includes a liquid crystal panel 2840 that is illuminated by a backlight 2850. Backlight 2850 includes a lightguide 2810 that receives light through an edge of the lightguide from a lamp 2802 that is housed in a side reflector (not shown) and a back reflector 2811 for reflecting light that is incident on the back reflector 2811 toward viewer 2899.

Optical stack 2801 includes a diffuser 2815 and two light redirecting films 2820 and 2830. In some cases, linear prisms of the two light redirecting films are oriented at an angle, e.g., substantially orthogonal, relative to each other. Optical film 2820 comprises a brightness enhancing prism layer 2821 disposed on a base layer 2822.

Optical film 2830 includes a matte layer 2831 and a prism layer 2833 which are disposed on a reflective polarizer layer 2832. The matte layer 2831 is adjacent the prism layer 2821 of film 2820 in the optical stack. In some configurations, both film 2830 and film 2820 and/or other optical films in the display system include matte layers. The reflective polarizer layer 2832 substantially reflects light that has a first polarization state and substantially transmits light that has a second polarization state, where the two polarization states are mutually orthogonal. For example, the average reflectance of reflective polarizer layer in the visible for the polarization state that is substantially reflected by the reflective polarizer is at least about 50%, or at least about 60%, or at least about 70%, or at least about 80%, or at least about 90%, or at least about 95%. As another example, the average transmittance of reflective polarizer layer 2832 in the visible for the polarization state that is substantially transmitted by the reflective polarizer 2832 is at least about 50%, or at least about 60%, or at least about 70%, or at least about 80%, or at least about 90%, or at least about 95%, or at least about 97%, or at least about 98%, or at least about 99%. In some cases, reflective polarizer layer 2832 substantially reflects light having a first linear polarization state (for example, along the x-direction) and substantially transmits light having a second linear polarization state (for example, along the y-direction).

Any suitable type of reflective polarizer may be used, for example, multilayer optical film (MOF) reflective polarizers; diffusely reflective polarizing film (DRPF), such as continuous/disperse phase polarizers or cholesteric reflective polarizers. The MOF, cholesteric and continuous/disperse phase reflective polarizers all rely on varying the refractive index profile within a film, usually a polymeric film, to selectively reflect light of one polarization state while transmitting light in an orthogonal polarization state.

An MOF reflective polarizer may be formed of alternating layers of different polymer materials, where one of the sets of alternating layers is formed of a birefringent material, where the refractive indices of the different materials are matched for light polarized in one linear polarization state and unmatched for light in the orthogonal linear polarization state. In such cases, an incident light in the matched polarization state is substantially transmitted through reflective polarizer and an incident light in the unmatched polarization state is substantially reflected by reflective polarizer. In some cases, an MOF reflective polarizer layer can include a stack of inorganic dielectric layers.

Suitable reflective polarizers are described in commonly owned U.S. patent application entitled Immersed Reflective Polarizer with Angular Confinement in Selected Planes of Incidence (Docket No. 65900US002) and U.S. Patent Application 61/254,691 (Docket No. 65809US002) both filed Oct. 24, 2009 and incorporated herein by reference. Another example of a suitable reflective polarizer is described in previously incorporated U.S. Pat. No. 5,882,774 and U.S. Patent Publication No. 2008/064133 which is incorporated herein in its entirety by reference. In some cases, reflective polarizer layer can be a multilayer optical film that reflects or transmits light by optical interference.

Examples of DRPF useful in connection with the present invention include continuous/disperse phase reflective polarizers as described in co-owned U.S. Pat. No. 5,825,543, incorporated herein by reference, and diffusely reflecting multilayer polarizers as described in e.g. co-owned U.S. Pat. No. 5,867,316, also incorporated herein by reference. Other suitable types of DRPF are described in U.S. Pat. No. 5,751,388.

Some examples of cholesteric polarizer useful in connection with the present invention include those described, for example, in U.S. Pat. No. 5,793,456, and U.S. Patent Publication No. 2002/0159019. Cholesteric polarizers are often provided along with a quarter wave retarding layer on the output side, so that the light transmitted through the cholesteric polarizer is converted to linear polarization.

One or more of the light management films in the optical film stack 2801 may be constrained relative to other films within the backlight 2850. For example, in some implementations optical film 2830 may be constrained at the edges of optical film 2830, whereas optical films 2820 and 2815 are not edge-restrained. In these implementations, the matte surface 2831 may be configured to achieve the coefficient of friction (COF), anti-warp properties, slope distribution, slope magnitude, haze and/or clarity properties as described herein.

Optical diffuser 2815 has the primary functions of hiding or masking lamp 2802 and homogenizing light that is emitted by lightguide 2811. Optical diffuser 2815 has a high optical haze and/or a high diffuse optical reflectance. For example, in some cases, the optical haze of the optical diffuser 2815 is not less than about 40%, or not less than about 50%, or not less than about 60%, or not less than about 70%, or not less than about 80%, or not less than about 85%, or not less than about 90%, or not less than about 95%. As another example, the diffuse optical reflectance of the optical diffuser 2815 is not less than about 30%, or not less than about 40%, or not less than about 50%, or not less than about 60%.

Optical diffuser 2815 can be or include any optical diffuser that may be desirable and/or available in an application. For example, optical diffuser 2815 can be or include a surface diffuser, a volume diffuser, or a combination thereof. For example, optical diffuser 2815 can include a plurality of particles having a first index of refraction n₁ dispersed in a binder or host medium having a different index of refraction n₂, where the difference between the two indices of refraction is at least about 0.01, or at least about 0.02, or at least about 0.03, or at least about 0.04, or at least about 0.05.

Back reflector 2811 receives light that is emitted by the lightguide away from viewer 2899 along the negative z-direction and reflects the received light towards the viewer. Display systems such as display system 2800 where lamp 2802 is placed along an edge of a lightguide 2810, are generally referred to as edge-lit or backlit displays or optical systems. In some cases, the back reflector 2811 can be partially reflective and partially transmissive. In some cases, the back reflector 2811 can be structured, for example, have a structured surface.

Back reflector 2811 can be any type reflector that may be desirable and/or practical in an application. For example, the back reflector can be a specular reflector, a semi-specular or semi-diffuse reflector, or a diffuse reflector. For example, the reflector can be an aluminized film or a multi-layer polymeric reflective film, such as an enhanced specular reflector (ESR) film (available from 3M Company, St. Paul, Minn.). As another example, back reflector 2811 can be a diffuse reflector having a white appearance.

Item 1 is an optical film stack, comprising a first optical film having a first major surface and a second major surface, the second major surface comprising a matte surface including a plurality of microstructures; and a second optical film having a third major surface and a fourth major surface, the third major surface of the second optical film adjacent to the matte surface of the first optical film, wherein a coefficient of friction between the first optical film and the second optical film is less than about 1.

Item 2 is the optical film stack of item 1, wherein the coefficient of friction is less than about 0.8.

Item 3 is the optical film stack of item 1, wherein the coefficient of friction is less than about 0.6.

Item 4 is the optical film stack of item 1, wherein the thickness of the first optical film is less than about 30 to 40 microns.

Item 5 is the optical film stack of item 1, wherein a Tg of the microstructured surface is about 70 C or about 50 C or about 30 C.

Item 6 is the optical film stack of item 1, wherein the COF is affected by surface chemistry during fabrication.

Item 7 is the optical film stack of item 1, wherein the first major surface comprises microstructures extending along a first direction of the first major surface.

Item 8 is the optical film stack of item 7, wherein the microstructures extending along the first direction of the first major surface have a maximum height that is different than a maximum height of the microstructures of the second major surface.

Item 9 is the optical film stack of item 7, wherein the microstructures extending along the first direction of the first major surface comprise linear prisms.

Item 10 is the optical film stack of item 7, wherein a height of a microstructure extending along the first direction of the first major surface varies along the first direction.

Item 11 is the optical film stack of item 1, wherein an average effective transmission of the first optical film is not less than about 1.80 to 1.85.

Item 12 is the optical film stack of item 1, wherein the third major surface of the second optical film comprises microstructures extending along a first direction.

Item 13 is the optical film stack of item 1, wherein the first major surface of the first optical film comprises microstructures extending along a first direction; and the third major surface of the second optical film comprises microstructures extending along a second direction, different from the first direction.

Item 14 is the optical film stack of item 1, wherein an average effective transmission of the optical film stack is not less than about 1%, 2%, 3%, 4%, 5%, 6%, 7%, or 8% compared to an optical film stack that has the same construction without the plurality of microstructures.

Item 15 is the optical film stack of item 1, wherein the first optical film comprises a base layer; and a matte layer disposed on the base layer, the matte layer including the matte surface.

Item 16 is the optical film stack of item 15, wherein the matte layer comprises a Tg in the range of about 50 C to 100 C.

Item 17 is the optical film stack of item 15, wherein the base layer comprises PET.

Item 18 is the optical film stack of item 15, wherein the base layer comprises a polarizing layer.

Item 19 is the optical film stack of item 18, wherein the polarizing film comprises a multilayer reflective polarizer.

Item 20 is the optical film stack of item 18, wherein an average reflectance of the polarizing layer for a substantially reflected polarization state is at least about 50%, or at least about 60%, or at least about 70%, or at least about 80%, or at least about 90%, or at least about 95%.

Item 21 is the optical film stack of item 18, wherein an average transmittance of the polarizing layer for a substantially transmitted polarization state is at least about 50%, or at least about 60%, or at least about 70%, or at least about 80%, or at least about 90%, or at least about 95%, or at least about 97%, or at least about 98%, or at least about 99%.

Item 22 is the optical film stack of item 15, wherein the base layer has an index of refraction not less than about 1.4 to about 1.8.

Item 23 is the optical film stack of item 15, wherein the matte layer has an index of refraction not less than about 1.4 to about 1.6.

Item 24 is the optical stack of item 15, wherein the matte layer comprises particles and an average thickness of the matte layer is greater than an average size of the particles by at least a factor of 2.

Item 25 is the optical stack of item 15, wherein the matte layer comprises particles and an average thickness of the matte layer is at least 2 microns greater than an average size of the particles.

Item 26 is the optical film stack of item 1, wherein the microstructures cover at least 75%, 80%, 85%, 90%, or 95% of the second major surface.

Item 27 is the optical film stack of item 1, wherein the optical haze of the first optical film is not greater than 1%, 2%, 3%, 4%, or 5% . . . .

Item 28 is the optical film stack of item 1, wherein the optical clarity of the first optical film is not greater than about 70% or greater than about 80%.

Item 29 is the optical film stack of item 1, wherein the microstructures have a slope distribution and the HWHM of the slope distribution is not greater than about 6 to about 4 degrees.

Item 30 is the optical film stack of item 1, wherein the second major surface has a slope distribution across the second major surface, the slope distribution having a HWHM that is not greater than about 32.4 to about 4 degrees.

Item 31 is the optical film stack of item 1 wherein no more than about 1 to about 7% of the microstructures have a slope magnitude greater than about 3.5 to about 5 degrees.

Item 32 is the optical film stack of item 1, wherein the third major surface comprises microstructures.

Item 33 is the optical film stack of item 32, wherein the microstructures of the third major surface comprise linear prisms.

Item 34 is the optical film stack of item 1, wherein the second optical film comprises a matte surface comprising microstructures on the fourth major surface.

Item 35 is the optical film stack of item 1, wherein the matte surface has an optical haze not greater than about 1% or about 2.5%.

Item 36 is the optical film stack of item 1, wherein the matte surface has an optical clarity that is not greater than about 70% or about 80%.

Item 37 is the optical film stack of item 1, wherein the substantial fraction of the microstructures is not disposed on particles that have an average size of greater than about 0.5 microns.

Item 38 is the optical film stack of item 1, wherein the first optical film does not include particles having an average size greater than 0.5 to about 0.1 microns.

Item 39 is the optical film stack of item 1, wherein an average height of the microstructures is not greater than about 1 to about 3 microns.

Item 40 is the optical film stack of item 1, wherein an amount of warp exhibited by the optical film stack is less than an amount of warp exhibited by the same optical film stack except without the microstructures.

Item 41 is an optical film, comprising: a polarizer layer having a first major surface and a second major surface; a prism layer disposed on the first major surface; and a matte layer disposed on the second major surface, the matte layer comprising a plurality of microstructures having a slope distribution, wherein a HWHM of the slope distribution is not greater than about 6 to about degrees, the matte layer, when adjacent a smooth surface, providing a coefficient of friction between the optical film and the smooth surface of less than about 1.

Item 42 is the optical film of item 41, wherein the coefficient of friction is less than about 0.8.

Item 43 is the optical film of item 41, wherein the coefficient of friction is less than about 0.7.

Item 44 is the optical film of item 41, wherein the coefficient of friction is less than about 0.6.

Item 45 is the optical film of item 41, wherein a thickness of the optical film is less than about 30 microns

Item 46 is the optical film of item 41, wherein prisms of the prism layer have a maximum height that is different than a maximum height of the microstructures.

Item 47 is the optical film of item 41, wherein prisms of the prism layer comprise linear prisms extending along a first direction of the first major surface.

Item 48 is the optical film of item 47, wherein a height of a linear prism extending along the first direction of the first major surface varies along the first direction.

Item 49 is the optical film of item 41, wherein the average effective transmission of the optical film is not less than about 1.5 to about 2.5.

Item 50 is the optical film of item 41, wherein an average effective transmission of the optical film is not less than about 1%, 2%, 3%, 4%, 5%, 6%, 7%, 8% compared to an optical film that has the same construction without the matte layer.

Item 51 is the optical film of item 41, wherein the matte layer comprises a Tg less than about 100 C, or less than about 90 C, or less than about 80 C, or less than about 70 C.

Item 52 is the optical film of item 41, wherein the matte layer has an index of refraction not less than about 1.4 to about 1.6.

Item 53 is the optical film of item 41, wherein the matte layer comprises particles and an average thickness of the matte portion is greater than an average size of the particles by at least a factor of 2.

Item 54 is the optical film of item 41, wherein the matte layer comprises particles and an average thickness of the matte portion is at least 2 microns greater than an average size of the particles.

Item 55 is the optical film of item 41, wherein the microstructures cover at least 75%, 80%, 85%, 90%, 95% of the matte layer.

Item 56 is the optical film of item 41, wherein matte layer has a slope distribution across the matte layer, the slope distribution having a HWHM that is not greater than about 2.5 to about 4 degrees.

Item 57 is the optical film of item 41, wherein no more than about 1 to about 7% of the microstructures have a slope magnitude greater than about 3.5 to about 5 degrees.

Item 58 is the optical film of item 41, wherein the matte layer has an optical haze not greater than about 1% to 2.5%.

Item 59 is the optical film of item 41, wherein the matte layer has an optical clarity that is not greater than about 70% to about 80%.

Item 60 is the optical film of item 41, wherein the substantial fraction of the microstructures is not disposed on particles that have an average size of greater than about 0.5 microns.

Item 61 is the optical film of item 41, wherein an average height of the microstructures is not greater than about 1 micron to about 3 microns.

Item 62 is an optical film, comprising: a polarizer layer having a first major surface and a second major surface; a prism layer disposed on the first major surface; and a matte layer disposed on the second major surface, the matte layer having a plurality of microstructures, wherein a coefficient of friction between the matte layer and a smooth surface is less than about 1.

Item 63 is the optical film of item 62, wherein the coefficient of friction is less than about 0.8.

Item 64 is the optical film of item 62, wherein the coefficient of friction is less than about 0.6.

Item 65 is the optical film of item 62, wherein the microstructures have a slope distribution and a HWHM of the slope distribution is not greater than about 6 to about 4 degrees.

Item 66 is the optical film of item 62, wherein the COF of the matte layer is influenced by surface chemistry during fabrication.

Item 67 is the optical film of item 62, wherein the matte layer comprises a Tg less than about 100 C, or less than about 90 C, or less than about 80 C, or less than about 70 C or less than 50 C or less than 30.

Item 68 is the optical film of item 62, wherein the COF of the matte layer is less than 1 and Tg is less than 30 C.

Item 69 is an optical film stack, comprising: a first optical film having a first major surface and a second major surface, the second major surface comprising a plurality of microstructures; and a second optical film having a third major surface and a fourth major surface, the third major surface of the second optical film oriented toward the second major surface of the first optical film, wherein the optical film stack warps less than an identical optical film stack with out the plurality of microstructures.

Item 70 is a backlight, comprising:

a light source;

a diffuser;

a first optical film, the first optical film comprising:
a first base layer having a first major surface, a second major surface, and a plurality of edges;
a first prism layer disposed on the first major surface of the first base layer; and
a first matte layer disposed on the second major surface of the first base layer, the matte layer the comprising microstructures;

a second optical film, the second optical film comprising:
a second base layer having a first major surface and a second major surface; and
a second prism layer disposed on the first major surface of the second base layer, the prism layer of the second optical film oriented toward the first matte layer and the second major surface of the second base layer oriented toward the diffuser, wherein the first optical film is constrained at the edges and the coefficient of friction between the first optical film and the second optical film is less than 1.

As used herein, terms such as “vertical”, “horizontal”, “above”, “below”, “left”, “right”, “upper” and “lower”, “clockwise” and “counter clockwise” and other similar terms, refer to relative positions as shown in the figures. In general, a physical embodiment can have a different orientation, and in that case, the terms are intended to refer to relative positions modified to the actual orientation of the device. For example, even if the image in FIG. 3 is flipped as compared to the orientation in the figure, first major surface 310 is still considered to be the top major surface.

All patents, patent applications, and other publications cited above are incorporated by reference into this document as if reproduced in full. While specific examples of the invention are described in detail above to facilitate explanation of various aspects of the invention, it should be understood that the intention is not to limit the invention to the specifics of the examples. Rather, the intention is to cover all modifications, embodiments, and alternatives falling within the scope of the invention as defined by the appended claims.

1. An optical film stack, comprising:
a first optical film having a first major surface and a second major surface, the second major surface comprising a matte surface including a plurality of microstructures; and
a second optical film having a third major surface and a fourth major surface, the third major surface of the second optical film adjacent to the matte surface of the first optical film, wherein a coefficient of friction between the first optical film and the second optical film is less than about 1.

2. (canceled)

3. The optical film stack of claim 1, wherein:
the first major surface of the first optical film comprises microstructures extending along a first direction; and
the third major surface of the second optical film comprises microstructures extending along a second direction, different from the first direction.

4-10. (canceled)

11. The optical film stack of claim 1, wherein a Tg is the microstructured surface is about 70 C or about 50 C or about 30 C.

12. The optical film stack of claim 1, wherein the COF is affected by surface chemistry during fabrication.

13. The optical film stack of claim 1, wherein the first major surface comprises microstructures extending along a first direction of the first major surface.

14. The optical film stack of claim 1, wherein an average effective transmission of the first optical film is not less than about 1.80 to 1.85.

15. The optical film stack of claim 1, wherein an average effective transmission of the optical film stack is not less than about 1%, 2%, 3%, 4%, 5%, 6%, 7%, or 8% compared to an optical film stack that has the same construction without the plurality of microstructures.

16. An optical film, comprising:
a polarizer layer having a first major surface and a second major surface;
a prism layer disposed on the first major surface; and
a matte layer disposed on the second major surface, the matte layer comprising a plurality of microstructures having a slope distribution, wherein a HWHM of the slope distribution is not greater than about 6 to about degrees, the matte layer, when adjacent a smooth surface, providing a coefficient of friction between the optical film and the smooth surface of less than about 1.

17. An optical film, comprising:
a polarizer layer having a first major surface and a second major surface;
a prism layer disposed on the first major surface; and
a matte layer disposed on the second major surface, the matte layer having a plurality of microstructures, wherein a coefficient of friction between the matte layer and a smooth surface is less than about 1.

18. An optical film stack, comprising:
a first optical film having a first major surface and a second major surface, the second major surface comprising a plurality of microstructures; and
a second optical film having a third major surface and a fourth major surface, the third major surface of the second optical film oriented toward the second major surface of the first optical film, wherein the optical film stack warps less than an identical optical film stack with out the plurality of microstructures.

19. A backlight, comprising:
a light source;
a diffuser;
a first optical film, the first optical film comprising:
a first base layer having a first major surface, a second major surface, and a plurality of edges;
a first prism layer disposed on the first major surface of the first base layer; and
a first matte layer disposed on the second major surface of the first base layer, the matte layer the comprising microstructures;
a second optical film, the second optical film comprising:
a second base layer having a first major surface and a second major surface; and
a second prism layer disposed on the first major surface of the second base layer, the prism layer of the second optical film oriented toward the first matte layer and the second major surface of the second base layer oriented toward the diffuser, wherein the first optical film is constrained at the edges and the coefficient of friction between the first optical film and the second optical film is less than 1.
